(19) United States
(12) Patent Application Publication
(10) Pub. No.: US 2022/0334572 A1
(43) Pub. Date: Oct. 20, 2022

(54) Method for Generating a Digital Twin of a System or Device

(71) Applicant: Siemens Aktiengesellschaft, Muenchen (DE)

(72) Inventors: Brent HANNIMAN, Nürnberg (DE); Steffen LAMPARTER, Feldkirchen (DE); Jens MECKEL, Postbauer-Heng (DE)

(21) Appl. No.: 17/762,837

(22) PCT Filed: Sep. 24, 2019
(86) PCT No.: PCT/EP2019/075599

§ 371 Date: Mar. 23, 2022

(51) Int. Cl. G05B 19/418

(52) U.S. Cl. CPC G05B 19/41885; G05B 2219/32359

(57) ABSTRACT

A method for generating a digital twin of a system or device includes identifying component data clusters within the first data source, where the component data clusters are assigned or assignable component types or component ID information relating to the system or device, allocating a respective component type designation or a respective component ID information designation to at least one of the identified component data clusters, and generating and storing the digital twin of the system or device.

### CROSS-REFERENCE TO RELATED APPLICATIONS

This is a U.S. national stage of application No. PCT/2019/075599 filed 24 Sep. 2019.

### BACKGROUND OF THE INVENTION

### 1. Field of the Invention

The present invention relates to a method for creating a digital twin of an installation or device.

### 2. Description of the Related Art

U.S. Pub. No. 2018/0210436 A1 discloses one example of a method for creating a digital twin that is based on an aggregation of static and dynamic digital models of the individual apparatuses of the installation. Here, an agglomeration algorithm is disclosed, which enables an overall view of the corresponding installation from the corresponding static and dynamic models of the individual apparatuses. The overall model furthermore then allows appropriate alarm notifications in relation to specific operating states of process apparatuses or of the corresponding industrial process.

The article “Resource virtualization: A core technology for developing cyber-physical production systems”; Yuqian Lu, Xun Xu; Journal of Manufacturing Systems, Volume 47, April 2018, pages 128-140 furthermore discloses a method for creating a digital twin for a factory based on a reference model of the factory, where this article explains a semantic model is developed and describes all of the required concepts and the physical resources of the factory in order to create the digital twin therefrom.

U.S. Pub. No. 2018/0157735 A1 discloses a system in which technical data in a multidisciplinary engineering system are combined into clusters of data. These may, for example, be used for various applications in the multidisciplinary engineering system. Here, the technical data may be grouped for various purposes, such as a group of apparatuses that are contained in a safety region of an automated unit, a group of apparatuses that are contained in an automation system, or a group of apparatuses that are associated with a particular bus controller.

One disadvantage of the cited prior art is that digital structures and subelements must be present as a basic requirement to create the digital twin, from which digital structures and subelements the digital twin, for example, of an installation or factory, can then be constructed. These methods cannot be applied in cases in which, for example, in the case of existing installations and factories, no such finished digital modules, for example, for components of the installation or factory, are present. Another disadvantage of the prior art is that it is necessary to predefine or to manually compile appropriate cluster structures in the case of engineering data.

### SUMMARY OF THE INVENTION

It view of the foregoing, it is therefore an object of the present invention to provide a method that makes it possible to generate a digital twin of an installation or device in a more flexible and/or simpler manner or to make available a digital twin generated in this way.

An alternative object of the present invention is to make available a method that makes it possible to create a digital twin of an installation or device for which there are not already digital twins or corresponding digital models at least for some components of the installation or device.

These and other objects and advantages are achieved by a method configured to create a digital twin of an installation or device, where a first data source containing automation engineering data in relation to automation and/or an automation plan of the installation or device or parts thereof is present, and where the automation engineering data comprise data from at least two data categories.

The method in accordance with the invention comprises:

a.) identifying component data clusters within the automation engineering data, where the component data clusters can be associated with or are associated with component types or component ID information in relation to the installation or device,

b.) assigning a respective component type designation or a respective component ID information designation to at least one of the identified component data clusters, and

c.) creating and storing the digital twin of the installation or device.

In the alternative embodiment, a method for creating a digital twin of an installation or device is provided, where a first data source from the following list of data sources is present:
automation engineering data related to automation and/or an automation plan of the installation or device or parts thereof,
mechanical computer-aided design (MCAD) data related to a mechanical and/or spatial plan of the device or installation or parts thereof, and/or related to a mechanical and/or spatial design of the device or installation or parts thereof,
electrical computer-aided design (ECAD) data related to an electrical plan and/or circuit diagram of the device or installation or parts thereof, and/or related to an electrical design and/or implemented circuit diagram of the device or installation or parts thereof,
robotics data related to a plan and/or a design of one or more robots of the device or installation, and
description data related to a plan and/or design of the device or installation or parts thereof.

The first data source in this case comprises data from at least two data categories.

The method in this case comprises:

a.) identifying component data clusters within the first data source, where the component data clusters can be associated with or are associated with component types or component ID information related to the device or installation,

b.) assigning a respective component type designation or a respective component ID information designation to at least one of the identified component data clusters, and

c.) creating and storing the digital twin of the installation or device.

Here, the clustering during method step a.) is configured such that the clustering occurs either by component types or by component ID information. The result of clustering in accordance with method step a.) is thus one or more clusters, where all of the identified clusters may each be associated or can be associated with respective different component types or all of the identified clusters may be associated or can be associated with respective different component ID information.

Feature b.) should be understood to mean that component data clusters that are associated with component types are each associated with a component type designation. Component data clusters that, by contrast, are associated with component ID information are accordingly associated with respective component ID information designations.

Feature b.) should furthermore be understood to mean that each of the at least one identified component data clusters is respectively associated with a corresponding designation, where different designations are generally associated with various ones of the data clusters. However, provision may also be made for the same designation to be associated with different data clusters.

The method in accordance with disclosed embodiments of the invention makes it possible to create a digital twin for an installation or device based on the data that have been created in the course of engineering, for example, of the automation engineering, for the device or installation. Appropriately clustering such data in accordance with the present disclosure makes it possible to identify the data from the first data source or the automation engineering data that belong to particular components of the installation or device and thus to generate a digital twin for the installation or device according to the present description. This simplifies the creation of such a digital twin in comparison with the methods and processes known from the prior art. This furthermore makes it possible to create a digital twin for a device or installation without digital models or digital twins for components of the device or installation already having to be present beforehand.

The creation of the digital twin may for example comprise suitable arrangement and/or storage of the information that has been identified or generated in one or more of additional the method steps a.), a1.), aa.), aa1.), b.), b1.), b2.), bb.), bb1.), bb2.), bbb.) described in accordance with the present disclosure. The creation of the digital twin may furthermore also consist of appropriate arrangement and/or storage of this information.

This arrangement and/or storage of the identified or generated data may for example be implemented in the form of a database in a digital twin database, or comprise such a digital twin database, and be present in any desired database format. Such database formats may, for example, be what are known as relational database formats or SQL database formats or else what are known as NoSQL database formats or knowledge graph data formats. Here, various parts of the digital twin may also be stored in various ones of the abovementioned formats.

The digital twin may furthermore also comprise further parts that are not present in any of the abovementioned database formats.

In contrast to the abovementioned relational databases (for example, SQL databases), “NoSQL” (for “not only SQL”) denotes databases with a nonrelational approach. NoSQL databases in connection with the present description are understood to mean databases that follow the nonrelational approach. NoSQL databases in the context of the present disclosure are particularly understood to mean document-oriented, graph-oriented, object-oriented, attribute value pair-oriented and/or column-oriented databases.

Modern NoSQL databases generally dispense with fixed structures of the tables, as their relational counterparts have, for example. As structure-free databases, they are based on more flexible techniques in order to define how data are stored. The name NoSQL may be attributed to the use of protocols for communication with the clients other than the SQL protocol.

A NoSQL database in connection with the present disclosure may, for example, be configured as a document-oriented database, a graph-oriented database, a knowledge graph, a distributed ACID database, a key value database, an attribute value pair-oriented database, a multi-value database, an object-oriented database and/or as a column-oriented database or a combination or development of such databases.

The digital twin may store the information or portions of the information as a relational database or the digital twin may comprise such a database. Furthermore, the digital twin may also store the information or portions of the information as a NoSQL database, one or more knowledge graphs, a nonrelational database, an OWL database, an RDF database and/or a database using SPARQL as consultation query, or the digital twin may comprise such databases.

Furthermore, component simulations belonging to the components thus identified may be selected, such as from a corresponding simulation database, for the creation of the digital twin. The respective components may be identified or the corresponding simulations may be selected in this case, for example, based on the associated component type designations or component ID information designations. The selected component simulations may then furthermore be parameterized accordingly by data, contained in the corresponding associated component data clusters, from the first data source or the automation engineering.

Using, for example, likewise identified relationship data between the various component data clusters, the selected component simulations may then furthermore be combined with methods known from the prior art to simulate the device or installation or parts thereof. Data contained within the respective data clusters may also be used in the course of such creation of a simulation of the device or installation. Such a simulation may then, for example, likewise form a digital twin in the sense of the present disclosure or may form part of such a digital twin.

A digital twin created in accordance with the present disclosure may, for example, be used by software systems or may be integrated into them. Such software systems may, for example, configured as systems for planning, developing, simulating, project managing and/or setting up devices or installations. Such a software system may furthermore also be configured for planning, developing, simulating, project managing and/or setting up the automation for a device or installation.

The data of the digital twin may thereby be used both in the course of planning and of setup of the device or installation according to the present disclosure and when planning and setting up future devices or installations.

The device or installation may, for example, be configured as a machine, an apparatus, a robot, a production installation or a comparable unit or may comprise such parts as components. Such a device or installation may, for example, comprise one or more components, drives, sensors, machines, apparatuses, communication units, and/or control units.

Components of an installation or device may, for example, be: functionally and/or spatially associated installation parts, segments, groups, components, actuators, sensors (for example, robots, transport units or particular types thereof (conveyor belt, and/or overhead track), motors, converters, sensors of a wide variety of types (for example, temperature sensors, pressure sensors, touch sensors, or flow rate sensors), machines of a wide variety of types (for example machine tools, presses, extruders, injection molding machines) and their subcomponents.

Component types of components contained in the installation or device are understood, for example, to mean names, designations and/or a description of particular types or particular type categories of these components. Such component types may be for example a line, a robot, a cell, an actuator, a motor, a sensor, a temperature sensor, a converter, a transport unit and/or comparable component types.

Component ID information on the other hand is understood to mean information that characterizes and/or identifies quite specific entities of components present in the device or installation. Such component ID information may, for example, be product names, order numbers, serial numbers, type identifiers or similar information identifying a particular component, in particular uniquely identifying the component.

Component clusters in accordance with the present disclosure may, for example, be component type clusters. What is characterizing for a particular component type cluster is that it contains automation engineering data or data from the first data source, or else data from further data sources, which are associated with a particular component type. An appropriate component type designation for such a cluster may, for example, be a name of the component type, a brief description or else an appropriate code for this component type. Examples of appropriate component types or else component type designations may be, for example, robot, transport unit, line, assembly unit, motor, converter, sensor, controller, or switch.

Component clusters in accordance with the present disclosure may furthermore, for example, be component ID information clusters. What is characterizing for a particular component ID information cluster is that it contains automation engineering data or data from the first data source, or else data from further data sources, which are associated with a particular component entity, which is characterized, for example, by particular ID information (for example, serial number, or product name). Component ID information clusters may in particular be those of the abovementioned clusters that are associated with a particular component entity, which is, for example, uniquely characterized by particular ID information. An appropriate component ID information designation for such a cluster may, for example, be the ID information. Examples of appropriate ID information may be, for example, specific serial numbers, order numbers, brand names, for example, specifically for a product (Simatic S7-1512) or generally for a product family (S7 controller, Scalance switch), model type designations, or else generally model designations.

The difference between component types and component ID information in the context of the present disclosure is intended to be clarified slightly more using the following example. In this example, a particular device contains two motors with different serial numbers. In this example, in the course of corresponding clustering by component types, the automation engineering data associated with these motors could, for example, be associated with a data cluster associated with the component type “motor”. In the course of alternative or additional clustering by component ID information, the automation engineering data in relation to the motor with the first serial number could then furthermore be classified into a component ID information data cluster associated with this serial number, while the automation engineering data in relation to the motor with the second serial number could be classified into a component ID information data cluster associated with this second serial number.

The component data clusters may, for example, be identified by applying a clustering method to the data from the first data source or the automation engineering data for identifying the component data clusters within the first data source or the automation engineering data.

Here, the application of the clustering method may, for example, involve an automated clustering method. In this case, for example, the data from the first data source or the automation engineering data may be clustered using appropriate software which, when executed, executes the clustering method automatically. In this case, for example, one or else more clustering algorithms may be implemented in the context of the software.

Furthermore, the application of the clustering method may also, for example, involve a semiautomated clustering method. This may be implemented, for example, via appropriate software which, when executed, executes the clustering method semiautomatically. This may, for example, be implemented such that, when the clustering method is executed, the software expects corresponding user inputs at particular times.

Quite generally, cluster is the name given to groups of similar data points or data groups that are formed through cluster analysis.

Cluster analysis or clustering is understood to be what is known as a “machine learning” technique, in which data or data points are grouped into what are known as “clusters”. For a set of data or data points, it is possible, for example, to use a cluster analysis method, a clustering method or a clustering algorithm in order to classify each datum or each data point into a particular group. Such a group is then referred to as a “cluster”. Here, data or data points that are contained in the same group (i.e., the same cluster) have similar properties and/or features, while data points in different groups have highly different properties and/or features.

In mathematical terms, clusters consist of objects that have a smaller distance (or by contrast: higher similarity) to one another than to the objects in other clusters. It is possible to distinguish between corresponding clustering methods for example by the distance or proximity measures used between objects in the clusters, but also between entire clusters. Furthermore or as an alternative, it is also possible to distinguish corresponding clustering methods by respective calculation rules for such distance measures.

Cluster analysis or clustering methods are understood to mean methods for discovering similarity structures in large datasets. These include, for example, supervised or unsupervised machine learning methods, such as k-means or DBSCAN. Clusters are the result of the cluster analysis. The advantage here is that the data analysis can be performed fully automatically. Supervised learning would be expedient if data are already present in contextualized form. Unsupervised learning algorithms also make it possible to find similarity structures in data that are not yet contextualized. The clusters that are found may be analyzed here by an expert in the field of the automation system and agents may conveniently be generated from the clusters that are found.

The application of the clustering method may, for example, comprise applying a clustering algorithm or else applying multiple clustering algorithms, for example, successively. Such clustering algorithms may be, for example, “K-means clustering”, “mean shift clustering”, “expectation maximization (EM) clustering using Gaussian mixture models (GMM)”, “agglomerative hierarchical clustering” and/or “density-based spatial clustering”, such as density-based spatial clustering of applications with noise (DBSCAN)”. Further examples of clustering algorithms may be, for example, the following algorithms: “mini batch K-means”, “affinity propagation”, “mean shift”, “spectral clustering”, “Ward”, “agglomeration clustering”, “Birch”, “Gaussian mixture”.

In cluster analysis or clustering methods, it is necessary to calculate distances or (dis)similarities between two objects, one object and one cluster or two clusters. Depending on the type of underlying objects, data or variables, various distance measures are used. In what are known as categorical objects, data or variables (generally data that are associated with or able to be associated with particular categories or classes), use is often made of similarity measures, i.e., a similarity value of zero means that the objects have maximum dissimilarity. These may be converted into distance measures. In the case of numerical or metric variables, use is made of distance measures, i.e., a distance measure of zero means that the objects have a distance of zero, i.e., have maximum similarity. There are furthermore also appropriate distance or similarity measures for other types of variables, such as binary data, text data or timeseries data.

When performing the clustering method or a clustering algorithm in accordance with the present disclosure, in this case, depending on the type of data categories that are used for the data from the first data source or the automation engineering data, it is possible to use the widest variety of customary distance measures or similarity measures for numerical data, binary data, string data, categorical data, text data and/or timeseries data.

A clustering method in accordance with the present disclosure may, in this case, be configured as explained above. Here case, use is made of techniques for identifying similarities between the data within the data collection under consideration. The clustering method may furthermore, for example, comprise the application of a specific clustering algorithm. The clustering method may additionally also be multistage and may comprise the use of two or more appropriate clustering algorithms (such as sequentially).

Examples of such clustering methods or algorithms are:
“unsupervised clustering”,
the K-means clustering method,
image processing methods for identifying associated structures within images or image information that are present, and/or
a combination of the abovementioned methods.

Here, the clustering method that is used may be selected in a manner adapted to the data types within the data collection that is present.

Method step a.) may possibly also be executed multiple times in succession by applying the first clustering method in each case to the results of the preceding clustering step. Further treatment or processing of the results from the previous clustering step may possibly also occur between the clustering steps.

The sequence of method steps a.) and b.) may furthermore also be executed multiple times in succession by, after allocating appropriate designations for the identified clusters, reapplying a clustering method to these identified clusters.

The component data clusters may, for example, be identified by applying a clustering method to the first data source or the automation engineering data. The component data clusters may furthermore also be identified using an appropriate assignment database, for example, a cluster assignment database, where such a database comprises associations, for example, already identified at earlier times, of automation engineering data or data from the first data source with particular clusters. The component data clusters may additionally also be identified using an appropriate association neural network, for example, a cluster association neural network. Such a cluster association neural network may for example have been trained using previously ascertained associations of automation engineering data or data from the first data source with clusters.

The identification of the component data clusters may, for example, also comprise several of the abovementioned methods in parallel or else sequentially.

Automation engineering data are, for example, data as are created and/or provided to automate and/or control the installation or device. Such data are created, for example, in what are known as engineering systems that are used, for example, to create appropriate control programs and to parameterize the components of the installation or device and also the corresponding control operations accordingly. One example of such an engineering system is, for example, commercially available software with the product name “TIA portal”.

Here, automation engineering data may comprise a wide variety of data, for example, one or more control programs, variables, “tags”, program modules, function modules, data modules, program blocks, “program organizational units” (POUs), a list of used data types, definitions of user-defined data types (“user-defined type” (UDT)), ID information regarding components, configuration data, call information for program elements, comments, control programs, parts of control programs and/or comparable data.

Data categories of the automation engineering data may, for example, be:
variables or “tags”,
program modules, function modules, data modules, program blocks or POUs (POU: program organizational unit),
user-defined data types (UDTs),
information regarding components of the device or installation,
call information for program modules or POUs, or
comments or comparable data categories.

Here, data from a particular data category within the automation engineering data may be collected, for example, to form a corresponding list, or else be associated with one another in a database or comparable structure. The compilation of data from a respective data category from the automation engineering data may also be created in preparation for performing the method in accordance with the present disclosure. Such a compilation of data may, for example, occur in order thereafter to export the corresponding data from a corresponding automation engineering system and then use it in the course of performing a method in accordance with the present disclosure.

The data belonging to a respective one of the data categories may, for example, also already be present in the form of lists, tables and/or database structures within the automation engineering data or be made available as such by a corresponding engineering system. By way of example, data from the corresponding abovementioned data categories may be present or be made available in the form of a tag or variables list, of a POU list, data type list, hardware component list, call structure and/or UDT list.

Here, the individual data within the data category of the automation engineering data may furthermore each comprise meta-information regarding the respective data. Such meta-information may, for example, be names, comments, references, physical units, ID information (such as for example type names, serial numbers, ID numbers, function designations, functionality or the like) or other additional information in relation to the respective data.

In this case, for example, the following information characteristic of the respective data categories may be used for a clustering method or a clustering algorithm applied to automation engineering data:
names or designations associated with the respective data (for example, names or designations of variables, tags, program modules, function modules, data modules, UDTs, etc.), or
text information associated with the respective data (for example meta-information, comments or description information regarding variables, tags, program modules, function modules, data modules, UDTs, and/or device/installation parts or components).

Further information that may likewise be used in the course of a clustering method or algorithm to form appropriate ones of said data categories, for example, are:
data types of variables, tags or, for example, also data types used by a data module, function module or program module;
number of inputs and/or outputs of a data module, function module or program module or else names/designations of the inputs and/or outputs of such modules;
number, names and designations of further such modules called by a particular data module, function module or program module;
further comparable information regarding the data categories of automation engineering data according to the present description.

The same applies not only to automation engineering data or data from the first data source, but also to any comparable data in accordance with the present disclosure.

The component type designations or component ID information designations may for example be assigned to the respective identified component data clusters manually, in an automated manner or else in a partially automated manner.

In the case of a manual assignment, it is possible, for example, to display to a user the correspondingly associated automation engineering data or the corresponding data from the first or a further data source in accordance with the present disclosure for each of the data clusters on a screen. Meta-information from the data sources in relation to these data may in particular also be displayed. These data may then be used by a user to identify an appropriate component type or a component ID information designation.

The component type designation or the component ID information designation may, for example, also be assigned in an automated manner. To this end, provision may be made, for example, for a database and/or a neural network. This may, for example, be a database in accordance with the present disclosure that stores the results of clustering steps already performed in the past in accordance with the present disclosure, the results of the assignment of appropriate designations to clusters in accordance with the present disclosure and identified relationship information in accordance with the present disclosure. This may furthermore also be a neural network in accordance with the present disclosure that has been trained with the results of earlier clustering steps in accordance with the present disclosure, results of relationship assignment steps in accordance with the present disclosure or else relationship information in accordance with the present disclosure.

In the course of the automated assignment of the component type designations or component ID information designations, appropriate cluster compilations in the database may, for example, be identified or input into the corresponding neural network. An appropriate relationship for the corresponding cluster may then, for example, be ascertained based on the database. When using the neural network, an appropriate designation, for example, an output, may be information from the neural network following the input of corresponding data associated with the cluster.

For an automated assignment of the component type designations or component ID information designations, it is also possible, for example, to automatically analyze meta-information from said data sources regarding these data and then to automatically select and/or create an appropriate designation therefrom.

In a partially automated mode of the assignment of appropriate designations to clusters, suggestions for such assignments may also be created automatically, for example, in one of the ways mentioned above. These suggestions may then be displayed to a user. By selecting one of the suggestions—and possibly the user adapting the corresponding suggestion—the selected suggestion may then be assigned to the identification of an appropriate component type or a component ID information designation.

In one advantageous embodiment, the method may be implemented such that, following method step a.) and before method step c.), the following are performed:

a1.) identifying subcomponent data clusters within the identified component data clusters, where the subcomponent data clusters can be associated with or are associated with subcomponent types of subcomponent ID information in relation to the installation or device,

and

following method step a1.) and before method step c.), the following is performed:

b1.) assigning a respective subcomponent type designation or a respective subcomponent ID information designation to at least one of the identified subcomponent data clusters.

A method configured in this way makes it possible, by identifying and designating subcomponent data clusters, to generate a hierarchal cluster model of the device or installation that further simplifies the creation of a digital twin for this device or installation. The creation of the digital twin is in particular simplified by the fact that such a hierarchy transfers a component and/or subcomponent structure of the device or installation from a cluster structure of the automation engineering data or the first data source for this device or installation. This thus gives rise to a cluster structure that comes close to or even corresponds to a component and/or subcomponent structure of the device or installation.

Method step a1.) in this case targets the identification of one or more subcomponent data clusters within the already identified component data clusters. Subcomponent data clusters identified within a particular component data cluster may in this case correspond to corresponding subcomponents of that component with which the component data cluster is associated.

When executing method steps a1.) and possibly b1.), a hierarchical system of clusters may, for example, be formed. In the course of clustering steps for identifying component type data clusters, a cluster for the component type “robot” could, for example, be identified in a first clustering step. In a further clustering step for identifying subcomponent type data clusters, a subcluster for a subcomponent “robot arm” could then for example be identified within this cluster. If, for example, a further clustering step for identifying subcomponent type data clusters is in turn able to be applied to these clusters for the “robot arm”, then it is possible, for example, to identify, within this data cluster, a cluster that corresponds to the component type “motor”.

It is thereby possible to generate a hierarchal cluster structure that corresponds to a hierarchical component structure of the device or installation. Further examples of such component or cluster hierarchies are for example similar “part of” hierarchies such as: “line-cell-robot-motor”.

Appropriate hierarchies may also be generated within component ID information clusters. By way of example, a cluster that is generally associated with robots of a particular manufacturer may thus contain subclusters that are associated with various robot types of this manufacturer. These robot type subclusters may then in turn be divided into further subclusters, which may each be associated with various robot models of this manufacturer that are associated with the respective types.

The wording “following method step” is understood to mean in the context of the present description that the corresponding method step is executed at any time after the method step, and does not have to follow it immediately. However, it may also follow it immediately.

The identification of the subcomponent data clusters according to method step a1.) may, for example, occur in the same way as the identification of the component data clusters in accordance with method step a.) and/or the present disclosure.

The subcomponent data clusters, subcomponent types and/or the subcomponent ID information may furthermore be configured in accordance with the component data clusters, component types and/or component ID information in accordance with the present disclosure.

The assignment of the respective subcomponent type designations or subcomponent ID information designations to the identified subcomponent data clusters in accordance with method step b1.) may also occur in accordance with the assignment of component type designations or component ID information designations to component data clusters in accordance with method step b.) and/or the present disclosure.

The subcomponent data clusters may, for example, be identified using a second clustering method or else the clustering method in accordance with the present disclosure. The subcomponent data clusters may furthermore also be identified using a cluster association database or a cluster association neural network in accordance with the present disclosure. The subcomponent data clusters may also be identified by way of a combination of the abovementioned methods.

In this case, the cluster association database may, for example, be configured such that associations, for example, already ascertained in the past, of cluster data with subcomponent data clusters are stored there. A corresponding cluster association neural network may furthermore also have been trained with associations, accordingly for example already ascertained in the past, of subcomponent data clusters with corresponding data clusters.

The second clustering method may in this case be configured as a clustering method in accordance with the present disclosure.

In this case, clustering by subcomponent types may occur, for example, after clustering by component types. Furthermore, clustering by subcomponent type ID information may, for example, follow clustering by component ID information.

Furthermore, clustering by component ID information may, for example, also follow clustering by component types, and clustering by component types may, for example, also follow clustering by component ID information. In the first case, clustering by ID information within the respective type clusters may, for example, occur following clustering that associates engineering data with particular component types. It is thereby then possible to associate, for example, engineering data, which are, for example, associated with a cluster for a component type, such as with different components of this component type.

The second clustering method may, for example, be applied to all of the component data clusters identified in method step b1.). As a result of the second clustering method, it is then possible, for example, to identify subcomponent data clusters, where some of the component data clusters may comprise one or more of the subcomponent data clusters, for example.

In this case, applying the second clustering method to the component data clusters may also have the result that no further subdivision is possible at least in one or more of the component data clusters.

Method step a1.) may accordingly also be performed multiple times. This results in a hierarchical structure via which the subcomponents identified in method step a1.) can be subdivided further into sub-subcomponents and sub-sub-subcomponents etc. and structured hierarchically.

In this case, a respective clustering method that has already been used up to now may be used for each of the clustering steps or a clustering method that has not yet been used up to now, such as a further suitable method in accordance with the present disclosure, may also be used.

In the case of multiple execution of method step a1.), the first clustering method may be applied to each of the results from the previous clustering step. Further treatment or processing of the results from the previous clustering step may possibly also occur between different clustering steps.

If method step a1.) is executed multiple times, method step b1.) may also accordingly be executed multiple times. In this case, sub-subcomponent designations and sub-sub-subcomponent designations etc. may then in turn be associated with the corresponding clusters for the corresponding subcomponents.

Examples of such a hierarchal arrangement may, for example, be a sequence of robot-robot arm-motor, or else line-cell-robot/motor.

This makes it possible to structure the installation or device hierarchically in relation to its associated automation data and also to provide this hierarchical structure with appropriate designations.

The digital twin created using this information may thus receive a hierarchal structure that corresponds to a hierarchal structure of the installation or device. This allows the installation or device to be analyzed on a wide variety of hierarchal levels.

Furthermore, in this case, there may be provision, in method step c.), for the digital twin to be created using the subcomponent data clusters.

A method according to the present description may furthermore be configured such that,

following method step a.) and/or a1.), the following is performed:

b2.) identifying relationship information of the component data clusters identified in accordance with method step a.) by evaluating the data from the first data source or the automation engineering data and/or additional information regarding these data, and/or identifying relationship information between subcomponent data clusters identified in accordance with method step a1.) by evaluating the data from the first data source or the automation engineering data and/or additional information regarding these data, where during method step c.), the digital twin is furthermore created using relationship information identified in the process.

Relationship information may, for example, be parent/child relationships between program modules, program components and/or program or component entities. Call information between various program modules, program components and/or program entities or program component entities may also be such relationship information. Furthermore, “is part of” relationships between components and their respective subcomponents may also be examples of relationship information.

By way of example, relationship information may be taken from additional information or metadata regarding some of the used data or else identified clusters. Relationship information may for example furthermore also be taken from cross-referencing or else material flow information.

Additional information regarding some or groups of data, which may also be referred to as metadata or meta-information regarding these data may, for example, be comments, descriptions, physical units, relationship descriptions regarding other data, functionalities, authors, authorizations or comparable information.

The relationship information may, for example, be identified by evaluating, for example, call information and/or call chains of program modules, function modules, data modules or generally POUs in accordance with the present disclosure. Functional relationships between various clusters, which contain various ones of the abovementioned modules, may thereby, for example, be identified.

There may thus, for example, be a case in which, in the course of a control program for an installation, a first function module calls a second function module. In the course of clustering, it may then, for example, turn out to be the case that the first function module is associated with a first installation component cluster, and thus a first installation component, and the second function module is associated with a second installation component cluster, and thus a second installation component. Due to the abovementioned call information, it is then possible to conclude that the second installation component has to be functionally associated with the first.

Relationship information may furthermore be ascertained, for example, based on meta-information regarding particular automation engineering data or data from the first data source or else comments regarding such data. Such meta-information or comments may, for example, directly contain such relationship information, such as a description and/or depiction of a functional association, a structural association and/or a spatial association. Relationship information may furthermore, for example, also be ascertained from names or ID information, for example, from the matching of parts of names of different data elements from the same category.

In the context of the present disclosure, in the present case, the wording “following method step a.) and/or a1.)” means, for example, that method step bb2.) may occur, for example, after method step a.), a1.), b.) and/or b1.). If the identification of the relationship information relates, at least inter alia, to subcomponent data clusters identified in accordance with method step a1.), then method step bb2.) may, for example, occur after method step a1.), b.) and/or b1.).

A method in accordance with the present disclosure may also be configured such that a second data source from the following list of data sources is present:
MCAD data related to a mechanical and/or spatial plan of the device or installation or parts thereof, and/or related to a mechanical and/or spatial design of the device or installation or parts thereof;
ECAD data related to an electrical plan and/or circuit diagram of the device or installation or parts thereof, and/or related to an electrical design and/or implemented circuit diagram of the device or installation or parts thereof;
robotics data related to a plan and/or a design of one or more robots of the device or installation;
description data related to a plan and/or design of the device or installation or parts thereof, where the method furthermore additionally comprises, before the creation of the digital twin in accordance with feature c.), the following:

aa.) identifying component data clusters within the second data source, where the component data clusters can be associated with or are associated with component types or component ID information in relation to the installation or device,

bb.) assigning a respective component type designation or a respective component ID information designation to at least one of the component data clusters identified in method step aa.),

bbb.) associating the component data clusters and/or subcomponent data clusters of the automation engineering data or from the first data source identified in method step b.) with the component data clusters of the data from the second data source identified in method step bb.).

After the abovementioned method steps have been performed, these method steps may, for example, furthermore be implemented again using a further data source from the list of the abovementioned data sources, or else another data source. It is thereby possible, through clustering in accordance with the present disclosure within a wide variety of data sources and performing a corresponding association step in accordance with abovementioned method step bbb.), to associate clusters identified within the various data sources with particular components or component parts.

It is thereby possible to generate a digital twin for a device or installation that associates data regarding this device or installation from a wide variety of data sources with the various parts or components of the installation or device and thus generates a consistent digital image of the device or installation. This simplifies and improves the creation of the digital twin, because the use of a larger number of data sources simplifies the association of the clusters with various components or installation parts of the device or installation and allows better networking of different types of data in relation to the installation or device.

The identification of the component data clusters in accordance with method step aa.) may in this case occur in accordance with the identification of component data clusters of method step a.) and/or the present disclosure. The assignment of the respective component type designation in accordance with method step bb.) may similarly occurs in accordance with the assignment of component type designations in accordance with method step b.) and/or the present disclosure.

In this case, an appropriately applied clustering method may be configured in accordance with the present disclosure. The identification of relationship information between the data clusters may also be configured in accordance with the present disclosure.

This simplifies and improves the creation of the digital twin, because the use of a larger number of data sources simplifies the association of the clusters with various components or installation parts of the device or installation and allows better networking of a larger number of different types of data in relation to the installation or device.

The identification of the component data clusters according to method step aa.) may, for example, occur by applying a further clustering method to the second data source.

In this case, the association of the component data clusters and/or the subcomponent data clusters of the automation engineering data or from the first data source with the component data clusters of the second data source may, for example, occur such that the respective component type designations or component ID information designations of the respective data clusters are compared with one another, and an appropriate association occurs when the designations are identical or similar.

Furthermore, in this case, one or more of the items of relationship information may, for example, also be compared between respective data clusters and used in the association. By way of example, when there are only similar designations of data clusters from the second data source and data clusters of the automation engineering data or from the first data source, corresponding data clusters may be associated with one another if they each have identical designations in regard to further data clusters.

The identification of the component data clusters within the data from the second data source may in this case occur in accordance with the identification of the component data clusters within the first data source or the automation engineering data according to the present disclosure. The identification of the component data clusters within the data from the second data source may thus, for example, also occur using an appropriate clustering method, an appropriate cluster assignment database and/or an appropriate cluster assignment neural network in each case in accordance with the present disclosure.

In this case, for example, the following information characteristic of the respective data categories may be applied for a clustering method applied to the abovementioned data categories (MCAD data, ECAD data, robotics data and/or description data) according to the present description, or a correspondingly applied clustering algorithm:
names or designations associated with the respective data;
text information associated with the respective data (for example meta-information, comments or description information).

Further information that may likewise be used in the course of a clustering method or algorithm for appropriate ones of the data categories are for example:
data or signal types of variables, tags, signals, inputs and outputs;
data types used by a data module, function module, program module or other software element;
connection types, connection names or designations and number of the connections of a particular mechanical, electrical and/or logic component or software component containing corresponding further such components;
number, class, type and/or configuration of the inputs and/or outputs of a mechanical, electromechanical, electrical or logic module or else of a software module or else names/designations of the inputs and/or outputs of such modules;
number, names or designations of further such modules called by a particular data module, function module or program module;
further comparable information regarding the data categories of MCAD data, ECAD data, robotics data and/or description data according to the present description.

Mechanical data or MCAD data may, for example, be: 3D geometries, kinematic information, points cloud information, names/designations/meta-information regarding mechanical components or parts, relationship information regarding various mechanical components or parts (for example, name, designation and/or number of further components connected to a particular part and, for example, also type and configuration of such connections), image data or construction or CAD data regarding corresponding mechanical components or parts thereof.

Electrical planning data or ECAD data may be, for example: function descriptions, location information, reference numbers for products, parts or component lists, schematic drawings, circuit diagrams, wiring diagrams, images of components or circuits, names, designations or number of inputs and/or outputs, information about dynamic behavior (for example, described as “macros”) or comparable data regarding electrical properties and/or configurations of the device or installation.

Robotics data may be, for example, in addition to automation engineering data, comparable data, for example, including data such as signal lists or robot programs.

The robotics data may also concern the device or installation as a whole, in particular when this consists substantially or even solely of one or more robots.

Description data may, for example, be planning and/or description data or else operating instructions in relation to the device or installation or else components and parts thereof. Such description data may in particular be present in standard document formats, such as text formats, Word format, PDF format, Excel format, Visio format, various image formats, flowchart formats, mind map formats or comparable document formats.

A method in accordance with the present disclosure may furthermore be such that, following method step aa.) and before method step bbb.), the following are performed:

aa1.) identifying subcomponent data clusters within the component data clusters identified in method step aa.), where subcomponent types or subcomponent ID information in relation to the installation or device can be associated with or are associated with the subcomponent data clusters, and

bb1.) assigning a respective subcomponent type designation or a respective subcomponent ID information designation to at least one of the identified subcomponent data clusters.

The wording “following method step aa.)” in this case also means that the method step mentioned here occurs any time following method step aa.) and does not necessarily have to follow method step aa.) immediately (but may do so).

The identification of subcomponent data clusters and the assignment of the subcomponent type designation to the corresponding subcomponent data clusters may in this case again be configured in accordance with the present disclosure.

The subcomponent data clusters may, for example, in this case be identified by applying a further second clustering method to the component data clusters identified within the data from the second data source. The further second clustering method may in this case be configured in the form of a clustering method in accordance with the present disclosure. It may in this case correspond to or be different from the clustering method or the further clustering method in accordance with the present disclosure.

Here, the subcomponent data clusters may also again be identified using an appropriate clustering association database and/or an appropriate clustering association neural network in accordance with the present disclosure.

In one advantageous embodiment, clustering by subcomponent types may, for example, follow clustering by component types. Furthermore, for example, clustering by subcomponent ID information may follow clustering by component ID information.

In this case, for example, clustering by component ID information may also follow clustering by component types and vice versa. In the first case, clustering by ID information within the respective type clusters may, for example, occur following clustering that associates data from the second data source with particular component types.

The further second clustering method may, for example, be applied to all of the component data clusters identified in method step bb1.). As a result of the second clustering method, it is then possible, for example, to identify subcomponent data clusters, where some of the component data clusters may comprise one or more of the subcomponent data clusters, for example.

The application of the further second clustering method to the component data clusters may in this case also have the result that no further clustering is possible at least in one or more of the component data clusters.

Method step aa1.) may also be performed multiple times. This results in a hierarchical structure via which the subcomponents identified in method step aa1.) can be subdivided further into sub-subcomponents and sub-sub-subcomponents etc. and structured hierarchically.

In this case, a clustering method that has already been used up to now may be used in each case for each of the clustering steps or a clustering method that has not yet been used up to now in the course of the method in accordance with the invention, such as in accordance with the present disclosure, may also be used.

Clustering by component ID information may furthermore, for example, follow clustering by component types and clustering by component types may furthermore, for example, follow clustering by component ID information. In the first case, clustering by ID information within the respective type cluster may, for example, occur following clustering that associates data from the second data source with particular component types, such that data from the second data source, which are associated, for example, with a cluster for one component type, may thus, for example, be associated with different component entities of this component type.

In the case of multiple execution of method step aa1.), the first clustering method may be applied to each of the results from the previous clustering step. Further treatment or processing of the results from the previous clustering step may possibly also occur between the clustering steps.

If method step aa1.) is executed multiple times, then method step bb1.) may also accordingly be executed multiple times. In this case, sub-subcomponent designations and sub-sub-subcomponent designations etc. may then be associated with the corresponding clusters for the corresponding subcomponents.

It is thereby possible to structure the installation or device hierarchically in relation to its associated data from the second data source and also to provide this hierarchical structure with appropriate designations.

The digital twin created using this information thus receives a hierarchical structure of the installation or device, which allows the installation or device to be analyzed on a wide variety of hierarchical levels.

Provision may furthermore be made in this case, in method step c.), for the digital twin to be created using the subcomponent data clusters.

A method in accordance with the present disclosure may furthermore be configured such that, following method step aa.) and/or aa1.), the following is performed:

bb2.) identifying relationship information between component data clusters identified in accordance with method step aa.) by evaluating the data from the second data source and/or additional information regarding these data, and/or identifying relationship information between subcomponent data clusters identified in accordance with method step aa1.) by evaluating the data from the second data source and/or additional information regarding these data, where during method step c.), the digital twin is furthermore created using identified relationship information.

Relationship information may in this case be configured in accordance with the present disclosed.

The ascertainment of the relationship information may in this case also be desi configured in accordance with the present disclosure. In this case, for example, the embodiments and explanations set forth in the context of ascertaining the relationship information from the automation engineering data or the data from the first data source may be transferred accordingly to the ascertainment of relationship information from the data from the second data source. Relationship information may in particular be obtained from corresponding robotics data in the same way as the explanation set forth in relation to the automation engineering data.

Relationship information may thus, for example, be ascertained from mechanical planning data or MCAD data. For this purpose, use may be made, for example, of 3D geometry information, component or parts lists or else kinematic information in relation to the geometrical design and location of components of the device or installation. The manner and configuration of connections of different components of the device or installation may also be evaluated and used accordingly, or appropriate image data may be evaluated and used accordingly in order to ascertain relationship information.

Electrical planning data or ECAD data may also be evaluated in the same way in order to ascertain the relationship information. In this case too, for example, location information, component or parts lists, schematic drawings, circuit diagrams, designations of inputs and/or outputs or else information about dynamic behavior may be evaluated accordingly in order to identify relationship information between various components of the device or installation.

Description data in accordance with the present disclosure may likewise be evaluated in order to identify relationship data. Relationship information between various components of the device or installation may in particular be contained directly in such planning and/or description documents.

In this case, in connection with the present description, the wording “following aa.)” and/or “following aa1.)” means that, for example, method step bb2.) may occur after method step aa.), aa1.), bb.) and/or bb1.). If the identification of the relationship information relates, at least inter alia, to subcomponent data clusters identified in accordance with method step aa1.), then method step bb2.) may, for example, occur after method step aa1.), bb.) and/or bb1.).

A method in accordance with the present disclosure may, for example, furthermore be configured such that, following method step a.), a1.), aa.), aa1.), b.), b1.), b2.), bb.), bb1.), bb2.), bbb.) and/or further method steps in accordance with the present disclosure, a result of the respective method step is stored in a cluster association database and/or or such that, following method step a.), a1.), aa.), aa1.), b.), b1.), b2.), bb.), bb1.), bb2.), bbb.) and/or further method steps in accordance with the present disclosure, a cluster association neural network is trained using results of the respective method step.

Such storage of the results of the method steps in a cluster association database or the use of the corresponding results of these method steps to train a cluster association neural network makes it possible to use the results obtained in the course of said method steps for future clustering steps or description assignment steps for correspondingly ascertained clusters.

The corresponding findings may thereby be used in future clustering methods, and the future clustering methods may thereby be further simplified and sped up.

The results from method step a.), a1.), aa.), aa1.), b.), b1.), b2.), bb.), bb1.), bb2.), bbb.) and/or further method steps in accordance with the present disclosure may, for example, be stored in a cluster association database in an SQL format or else NoSQL format. In this case, the database or the storage in the database may be configured in accordance with the present disclosure or may comprise components in accordance with the present disclosure.

The storage in the cluster association database may in this case be provided and configured such that the stored results can each be used in future analysis, for example, of corresponding data collections, data sources and/or installation part clusters.

In this case, such a cluster association database may, for example, store the association of particular data with a particular cluster or else the association of particular data or clusters with particular cluster designations or ID information designations. Furthermore, such a database may, for example, also store the association of different clusters with one another, as have been ascertained, for example in accordance with method step b2.), bb2.) or bbb.). In the course of such storage of associations of clusters with one another, ascertained relationship information between these clusters may, for example, also be stored.

The cluster association database may in this case comprise, for example, two subsegments, a cluster association type database region and a cluster association ID info database region. In this case, for example, the first of said database regions may store the association of corresponding cluster data with particular type descriptions or designations or further type information. The second mentioned database range may then, for example, store an association of corresponding data clusters with ID information.

The use of the result from the respective method step to train a corresponding neural network may, for example, be configured such that, following method step a.), a1.), aa.), aa1.), b.), b1.), b2.), bb.), bb1.), bb2.), bbb.) and/or further method steps according to the present description, the component data clusters or subcomponent data clusters ascertained on the basis of the used data are used to train a corresponding neural network to identify such component data clusters or subcomponent data clusters.

In this case, for example, the association of the data contained in the respective data cluster with the respective cluster and/or a component type or component ID information designation associated with this cluster may be used. Furthermore, the association of the respective component data clusters with particular associated real components, physical installation parts and/or particular designations may also be used to train the corresponding neural network.

A method in accordance with the present disclosure may furthermore be configured such that the cluster association database and/or the cluster association neural network is used when performing a method in accordance with the present disclosure, in particular such that the component data clusters and/or the subcomponent data clusters are identified using the cluster association database and/or the cluster association neural network, and/or such that the component type designation or component ID information designation and/or the subcomponent type designation or in each case one subcomponent ID information designation is assigned using the cluster association database and/or the cluster association neural network.

This may, for example, be configured such that the information, stored, for example, in accordance with the above disclosure in a corresponding database or a corresponding neural network, may then, for example, be used to divide further data collections, data sources and/or already ascertained data clusters into corresponding component data clusters and/or subcomponent data clusters.

In one advantageous embodiment, clustering occurs in accordance with method step a.), a1.), aa.), aa1.) and/or further method steps in accordance with the present disclosure using the database and/or the trained neural network.

In a further advantageous embodiment, the assignment of a designation and/or designation information occurs in accordance with method step b.), b1.), b2.), bb.), bb1.), bb2.) and/or further method steps in accordance with the present disclosure in accordance with the disclosure using the database and/or the trained neural network.

In a further advantageous embodiment, clusters are associated in accordance with method step bbb.) and/or further method steps in accordance with the present disclosure using the database and/or the trained neural network.

Thus, for example, the data from the first data source, the automation engineering data and/or the data from the second data source or further data sources may be supplied to the cluster association database, and associations, already made in the past, of data contained therein with particular clusters are then sought therein, and these cluster associations are then output. Furthermore, for example, data belonging to particular clusters from the first data source or the automation engineering data and/or data from the second or a further data source may be supplied to the cluster association database and component descriptions already associated with such clusters accordingly in the past may then be searched within the database, and these associations are then again output.

In a comparable manner, data from the first data source or automation engineering data and/or data from the second or further data sources may, for example, e be supplied to a neural network trained in accordance with the present disclosure, following which appropriate associations of some of these data with corresponding clusters are then output by the neural network. In order to ascertain appropriate component descriptions regarding particular ascertained cluster data, the data belonging to a particular cluster may, for example, again be input into a neural network trained in accordance with the present disclosure, where the neural network then outputs a corresponding component description regarding the associated cluster.

Provision may in this case furthermore be made for the digital twin and/or the cluster association database to formed as a relational database, a NoSQL database and/or a knowledge graph database.

The digital twin or the data of the digital twin may in this case be stored as a database in a digital twin database or comprise such a digital twin database and be present in any desired database format. Such database formats may, be for example, what are known as relational database formats or SQL database formats or what are known as NoSQL database formats and/or knowledge graph database formats.

The cluster association database may likewise be present in any desired database format. In this case, such database formats may also be, for example, what are known as relational database formats or SQL database formats or what are known as NoSQL database formats and/or knowledge graph database formats.

In this case, various parts of the digital twin and/or of the cluster association database may also be stored in various ones of the abovementioned formats.

The digital twin and/or the cluster association database may furthermore also comprise further parts that are not present in any of the abovementioned database formats.

The digital twin may store the information or portions of the information as a relational database or the digital twin may comprise such a database. Furthermore, the digital twin may also store the information or portions of the information in the form of a NoSQL database, one or more knowledge graphs, a nonrelational database, an OWL database, an RDF database and/or a database using SPARQL as consultation query, or the digital twin may comprise such databases.

In this case, said database formats, for example, a relational database, an SQL database, a NoSQL database and/or a knowledge graph, may furthermore be designed and configured in accordance with the present description.

It is also an object of the invention to provide a digital twin for a device or installation, where the digital twin has been created using a method in accordance with the present disclosure.

A digital twin generated in this way achieves the abovementioned objects, because it was created in a simplified manner using the method set forth in the present disclosure.

It is also an object of the invention to provide a computer-readable storage medium comprising a digital twin, a cluster association database and/or a cluster association neural network in accordance with the present disclosure.

A digital twin stored in this way achieves the abovementioned objects, because the digital twin was created in a simplified manner using the method set forth in the present disclosure. The cluster association database stored on the computer-readable storage medium and/or the cluster association neural network stored there furthermore allows the simplified creation of a digital twin in accordance with the present disclosure for a further device or installation, as explained in more detail in the present disclosure.

It is also an object of the invention to provide a way to use a digital twin in accordance with the present disclosure to identify inconsistencies between the automation engineering data or the data from the first data source and the data from the second data source.

Such inconsistencies between the automation engineering data or the data from the first data source and the data from the second data source may, for example, be:
differences in the number of the respectively identified component data clusters and/or subcomponent data clusters after clustering of the respective data;
differences in the respectively assigned component type designations and/or component ID information designations that have been assigned to the respective component data clusters or subcomponent data clusters;
differences in the relationship information that has been ascertained in each case between various ones of the identified component data clusters and/or subcomponent data clusters.

In a further method step, the identified inconsistencies may, for example, be displayed to a user. Furthermore, in a further method step, an input mask may be made available such that a user can, for example, manually input and/or change assigned component type designations and/or component ID information designations in relation to some of the component data clusters and/or subcomponent data clusters.

Provision may furthermore be made to display to a user, for example, as a result of a corresponding inconsistency check, for example, component type designations and/or component ID information designations in relation to respectively ascertained component data clusters and/or subcomponent data clusters from the first data source or the automation engineering data and the data from the second data source.

Furthermore, alternative suggestions for appropriate designations may, for example, be made to a user for each of the displayed component type designations and/or component ID information designations via a selection menu. Here, the alternative suggestions for appropriate designations may be taken from the cluster designations of the respective other data source. This means, for example, that all or a selection of those component type designations that were ascertained in the course of the cluster of the second data source are then made available to a component type designation of a particular data cluster within the first data source or the automation engineering data in a selection list.

The user may thereby be assisted for example in associating identified data clusters in both data sources with the correspondingly correct designations.

In a comparable manner, the respective relationship information that has been ascertained in the course of the clustering of the first data source or the automation engineering data and the data from the second data source may also be displayed, and appropriate designations for such relationship information may be displayed in appropriate drop-down menus. The relationships identified in the course of the clustering of both data sources may thus also be assimilated to one another.

This thus makes it possible not only to identify inconsistencies between the first data source or the automation engineering data and the data from the second data source, but also to assist a user in the process with rectifying such inconsistencies and possibly even correcting and/or supplementing both data sources accordingly.

In a further advantageous embodiment, the identified inconsistencies may also, for example, be used to ascertain faults in one or both of the data sources and to identify required steps to correct such faults. This may, for example, occur such that a user is given appropriate instructions and/or, for example, change suggestions are also already made automatically.

The method may furthermore also be configured such that such identified faults are corrected automatically on the basis of the information within the digital twin. In this case, it may, for example, be displayed to a user which of the values or terms have been corrected automatically in order to then offer the user further correction options.

It is a further object of the invention to provide a way to use a digital twin in accordance with the present disclosure to create a digital twin of a changed device or installation.

Such a digital twin for a changed device or installation or for the planning of a change to the device or installation may, for example, be created such that clusters associated with particular component types or component ID information are replaced with clusters associated with changed component types or component ID information. Replacement of the corresponding component types or individual components with alternative component types or individual components in the new digital twin may thus for example be considered for the changed device or installation.

Relationship information for corresponding component clusters or subcomponent clusters may also be adapted accordingly when the relationships (for example, a spatial or else a hierarchical relationship) of the corresponding components have accordingly changed or such a change is planned.

The data of this changed digital twin for the changed device or installation or the planned change to the device or installation may, for example, be used to create a corresponding simulation of the changed device or installation or to support the creation thereof.

The data of the digital twin may furthermore also be used for the changed device or installation, for example, in order to create a control program for the changed device or installation or to support a corresponding creation. These data may furthermore also be used to create a corresponding engineering project, MCAD data, ECAD data, robotics data and/or description data for the changed device or installation.

It is also an object of the invention to provide a way to the use a digital twin in accordance with the present disclosure to create a simulation of the device or installation or parts thereof and/or for the virtual commissioning of the device or installation or parts thereof.

In this case, the use of the digital twin to create a simulation is understood inter alia to mean that at least some of the data of the digital twin are used at least inter alia to create the simulation of the device or installation. In this case, it may be necessary for yet more other data or data sources and possibly also user inputs to be required to create the simulation.

The identified component data clusters and/or subcomponent data clusters, or type designations or ID information designations associated therewith, may thus, for example, be used to identify and to select appropriate simulation programs for the corresponding components, such as within a corresponding simulation database.

Identified relationship information between corresponding data clusters may furthermore, for example, be used to logically link simulation programs in relation to components associated with these data clusters.

Further data, such as within particular data clusters, may also likewise be used to create or parameterize a corresponding simulation. Such data may be, for example, 3D geometries or appropriate kinematic information regarding particular parts of the installation or device. Such information may furthermore be reference designations for products, parts lists and/or else appropriate schematic drawings or circuit diagrams of the device or installation. Description data such as flowcharts may also be such information that may be used to create and/or parameterize a simulation for the device or installation.

In a further advantageous embodiment, the data of the digital twin may also be used when linking various simulation programs each associated with components of the device or installation. In the case of such linking, the input and output data of a simulation in relation to a particular component of the device or installation have to be logically linked, inter alia, to corresponding input and output data of a simulation in relation to a further component of the device or installation linked at least logically to the component. This may allow, for example, correct communication between both simulations. Such a logic link and input and output signals of different simulations is referred to, for example, as “signal mapping”.

Therefore, in a further advantageous embodiment, a digital twin in accordance with the present disclosure may also be used for such “signal mapping” between simulation programs associated with various components and/or subcomponents of the installation or device.

Such signal mapping may, for example, occur using the digital twin of the device or installation or at least be supported by way of the digital twin. In this case, for example, information from further data sources in relation to the identified component types or component ID information may be used. Information stored in the digital twin itself, or else information from the corresponding data clusters themselves, may however also be used for this purpose, such as appropriate variable names, variable information, function modules, function module information, data modules and/or corresponding data module information. By way of example, names, designations, arrangements and/or similar information in relation to input and output signals of a corresponding simulation for a corresponding component may be taken from this information. The input and output signals of a simulation for a particular component may then be linked to the corresponding input and output signals of a further simulation for a further component linked at least logically to the particular component based on such information.

Such a link may in turn be made automatically or by virtue of a user being assisted with the manual association of appropriate input and output signals, such as through the display of appropriate suggestions.

Virtual commissioning of the device or installation is understood to mean implementing the automation of the device or installation based on a digital model of the device or installation and/or a simulation of the device or installation. In this case, for example, the simulation or the model of the device or installation may be linked to real control hardware for the device or installation (i.e., “hardware in the loop”). The simulation or the model of the device or installation may furthermore also be linked to a simulation of the control hardware (i.e., “software in the loop”).

The control for the installation and the operation of the installation may thereby be configured without the real installation already having to be present in functional form.

In this case, a digital twin in accordance with the present disclosure may, for example, be used to create such a simulation of the device or installation, as already explained in the present description. Furthermore, for example, a control program and/or its modules may be taken from the digital twin in order to set up the appropriate control hardware or control hardware simulation accordingly. Furthermore, further data expedient or required for the virtual commissioning may also be taken from the digital twin, such as further information regarding used hardware components, regarding the used communication protocols or similar information.

It is also an object of the invention to provide a way to use a digital twin in accordance with the present disclosure to check whether the digital twin corresponds to original planning data of the device or installation.

Original planning data may in this case, for example, be data of a digital development system for the device or installation, or else document-based plans, drawings, parts lists, function descriptions and/or other planning data for the device or installation.

In the course of the check as to whether the digital twin corresponds to the original planning data of the device or installation, a check may be performed, for example, to determine whether the digital twin has the same components and/or subcomponents as likewise stipulated in the course of the original planning data. Furthermore, a check may also be performed, for example, to determine whether the components and/or subcomponents of the device or installation in accordance with the digital twin have the same relationship information as originally stipulated in the planning data for the device or installation.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is described in more detail below by way of example with reference to the appended figures, in which:

FIG. 1 shows an exemplary schematic illustration of an assembly unit in accordance with an embodiment of the invention;

FIG. 2 shows a list of various engineering and/or planning data for the assembly unit of FIG. 1;

FIG. 3 shows a schematic sequence of the creation of a digital twin for the assembly unit of FIG. 1;

FIG. 4 shows a schematic sequence when creating a digital twin for the assembly unit of FIG. 1 using data from various engineering data sources;

FIG. 5 shows a depiction of data from various data categories of the automation engineering data for an exemplary description of a sequence for creating a digital twin for the assembly unit of FIG. 1;

FIG. 6 shows the result of a 1st clustering step in relation to the automation engineering data of FIG. 2;

FIG. 7 shows the result of a 2nd clustering step in relation to the automation engineering data of FIG. 2;

FIG. 8 shows the result of the 2nd clustering step of FIG. 7 with furthermore identified relationship associations between various components;

FIG. 9 shows an exemplary illustration of data from various data categories in relation to mechanical CAD data of the assembly unit of FIG. 1;

FIG. 10 shows the result of applying a 1st and 2nd clustering step and a relationship association to the mechanical CAD data of FIG. 9;

FIG. 11 shows a schematic graphical illustration of a digital twin of the assembly unit based on the data and information ascertained in the exemplary method steps in accordance with the invention; and

FIG. 12 is a flowchart of the method in accordance with the invention.

### DETAILED DESCRIPTION OF THE EXEMPLARY EMBODIMENTS

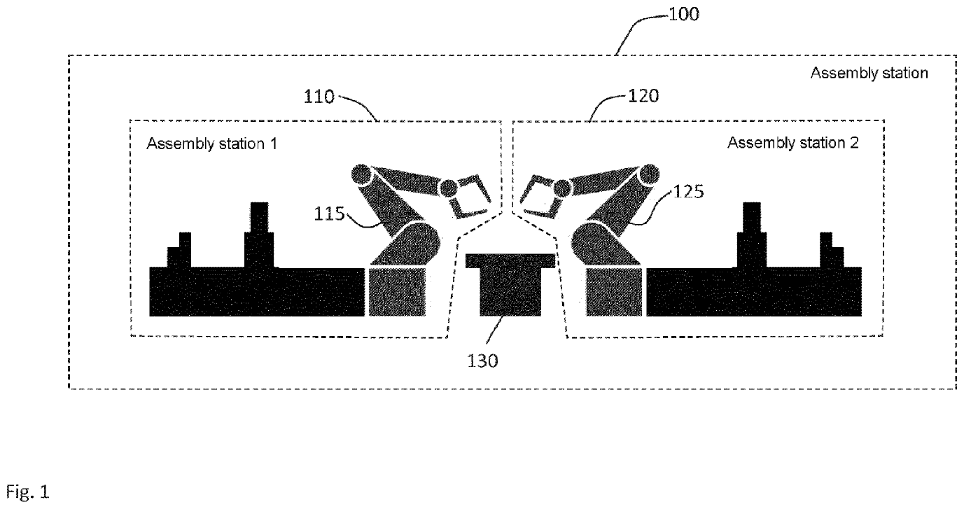

FIG. 1 shows an assembly station 100 or assembly unit 100 having a first transport station 110 and a second transport station 120. Here, the first transport station 110 comprises a first robot unit 115 and the second transport station 120 comprises a second robot unit 125. The assembly station 100 furthermore comprises an assembly platform 130.

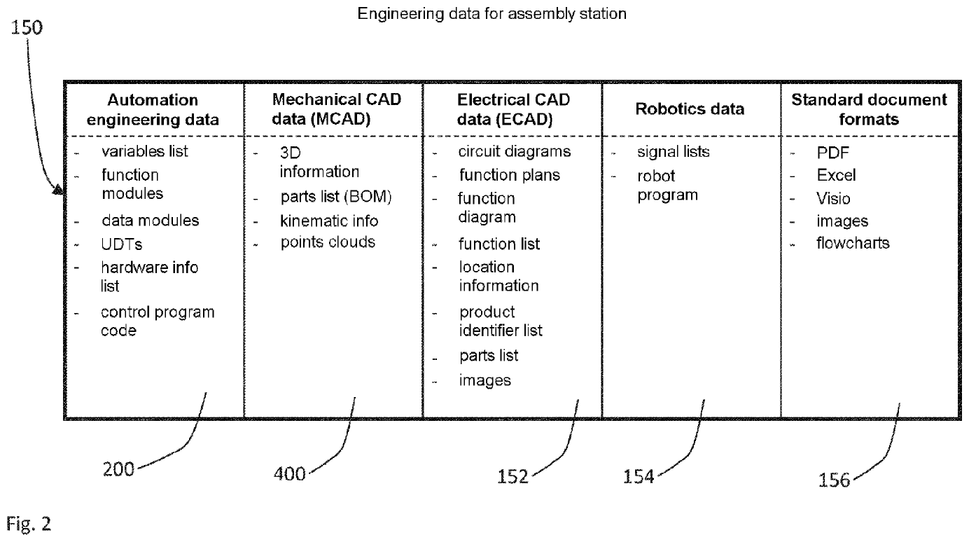

FIG. 2 shows a list of engineering data 150 for the assembly station 100 illustrated in FIG. 1. The engineering data 150 in this case comprise automation engineering data 200, mechanical CAD data (MCAD) 400, electrical CAD data (ECAD) 152, robotics data 154 and data in standard document formats 156.

In this case, the automation engineering data 200 comprise data that are required or used in the course of automating the assembly station 100, for example, using appropriate controllers or control units (for example, one or more programmable logic controllers).

Such data are, for example, a variables list of the variables used in the course of the control of the assembly unit 100 within such a control operation. The automation engineering data 200 furthermore comprise function modules and data modules used for control or the code of a corresponding control program for controlling the assembly unit via an appropriate controller or appropriate programmable logic controller.

The automation engineering data 200 also comprise a list of user-defined data formats (user-defined types (“UDTs”) that have been created or set up in the course of creating the automation engineering data 150.

The automation engineering data 200 furthermore comprise a list of information regarding the hardware components used in the assembly station 100. This information may, for example, comprise component names, component ID information (for example, brand names, serial numbers, order numbers or the like), component type designations, component description information, a list of respectively used parameters and/or corresponding parameter limit values, geometric information regarding corresponding hardware components and/or additional, background or support information regarding the corresponding hardware components.

The MCAD data 400 comprise a parts list of the components of the assembly station 100, 3D information regarding the components of the assembly station 100 and regarding the assembly station 100 itself. The MCAD data 400 furthermore comprise kinematic information in relation to individual components of the assembly station 100, assembly station 100 as a whole, and between various ones of the components of the assembly station 100. The MCAD data furthermore also comprise point clouds information in relation to individual components of the assembly station 100 and the assembly station 100 as a whole.

The ECAD data 152 comprise circuit diagrams of the assembly station 100 and its components, function plans, function diagrams, function lists and location information in relation to electrical modules and components of the components of the assembly station 100. The ECAD data furthermore comprise a parts list of used electrical and electronic components, a corresponding product identifier list and images of such components and corresponding circuits as are used in the context of the assembly station 100 and the components of the assembly station 100.

The robotics data 154 of the engineering data 150 for the assembly station 100 comprise signal lists of the robot units 115, 125 of the assembly station 100 and robot programs for the robot units 115, 125 of the assembly station 100.

The information contained in the engineering data 150 for the assembly station 100 in standard document formats 156 comprise PDF files, Excel files, Visio files, images and flowcharts containing information in relation to the assembly station 100 and its components. Such information may be, for example, function descriptions, operating instructions, parameter and other data lists, visual depictions and similar information.

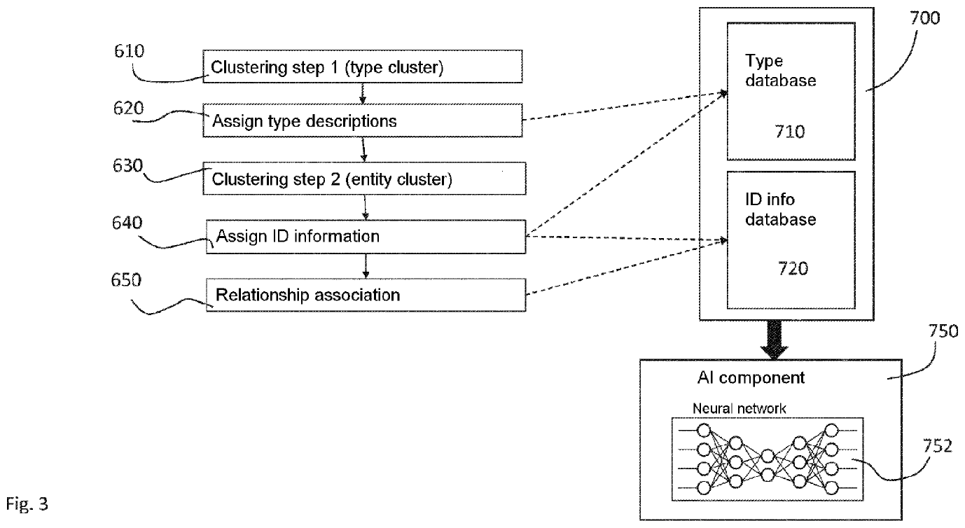

FIG. 3 shows an exemplary schematic sequence for creating data for a digital twin 800 for the assembly station 100 in accordance with the present disclosure. This sequence is explained by way of example below with reference to the exemplary clustering of automation engineering data 200 for the assembly station 100. Here, the automation engineering data 200 also form one example of a first data source according to the present description.

The creation of the digital twin 800 of FIG. 3 begins with a first clustering step 610, in which type clusters within data selected for the clustering are identified from the automation engineering data 200 using a first clustering method. Here, respective data that belong to a particular component type are each assigned to an associated cluster. Such component types may be, for example, a robot, a line, an assembly station, a motor, a converter, a sensor or similar component types. This is explained in even more detail in connection with the following figures.

In a second assignment step 620, appropriate type descriptions are associated with the identified type clusters. This assignment may, for example, be performed manually by a user or semiautomatically or automatically based on stored corresponding information.

FIG. 3 furthermore shows a database 700 that comprises a type database 710 and an ID info database 720.

The results from the assignment step 620 are then stored accordingly in the type database 710 by associating the information regarding the identified type clusters, for example, inter alia, with the respective type descriptions within the database.

Next, in a second clustering step 630, ID information clusters within the type clusters found in the first clustering step 610 are identified. Here, within a type cluster, respective data that belong to a particular component or component entity are associated with a corresponding cluster. Such particular components or component entities may, for example, be characterized by a serial number or order number, or by an appropriate product name or manufacturer name. Here, various ID information clusters regarding various components may, for example, be present within one of the identified type clusters. The identified type cluster may furthermore also correspond to precisely one ID information cluster, i.e., there is exactly one component of a particular type.

Next, in a further assignment step 640, appropriate ID information is assigned to each of the identified ID information clusters. Such ID information may then, for example, even be the corresponding serial or order numbers, product names or manufacturer names already mentioned above.

This is followed by a relationship association step 650 in which relationships between various ones of the identified type clusters and/or ID information clusters are identified. Such relationships may be for example relationships such as “functionally associated”, “is part of”, “is associated”, “is connected to” or the like relationships. Such relationships may, for example, be ascertained based on the relationships of some of the data within the automation engineering data 200. Such relationships may thus, for example, be derived from call chains or orders of program modules, function modules, data modules or similar structures. Relationships may furthermore also be concluded from variable names or similar data.

The data stored in the type database 710 and the ID information database 720 are furthermore used to train an AI component 750 with a neural network 752. By way of example, the association of particular data with particular clusters and/or the association of particular designations with particular clusters and/or the data contained therein is used to train the neural network 752.

The trained neural network 752 of the AI component 750 may then, for example, also be used in the course of the clustering steps 610, 630 and the assignment steps 620, 640 illustrated in FIG. 3. Thus, for example, in the course of one of the clustering steps 610, 630, the source data may be supplied to the trained the neural network 752, which may then output a corresponding cluster structure or corresponding clusters or cluster designations associated with the individual data and thus accordingly supplement or possibly even replace clustering methods used in the respective clustering steps 610, 630.

In the same way, the AI component 750 may also be used for the type description assignment 620 or the ID information assignment step 640. The relationships identified in the relationship association step 650 may furthermore also be used to appropriately train the neural network 752, and the relationship association step 650 may thus also be supported later by an appropriately trained neural network 752.

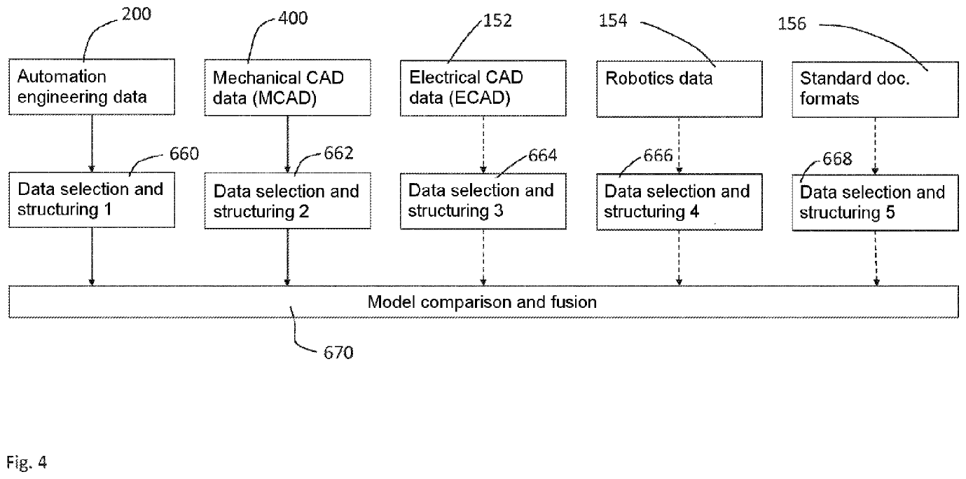

FIG. 4 shows an exemplary schematic illustration of steps for creating a digital twin 800 in accordance with the present disclosure using data from various engineering data sources 200, 400, 152, 154, 156.

For this purpose, automation engineering data 200, as explained and elucidated in more detail by way of example in connection with FIG. 2, are subjected to one or more data selection and structuring steps 660, as are explained in more detail for example in the context of FIG. 3. Mechanical CAD data 400, as are likewise explained in more detail, for example, in connection with FIG. 2, are furthermore likewise subjected to one or more data selection and structuring steps 662, as have already been explained in more detail in connection with FIG. 3. In the same way, the electrical CAD data 152, the robotics data 154 and the standard document data 156, which are likewise explained in more detail in connection with FIG. 2, are each subjected to data selection and structuring steps 664, 666, 668, where these data selection and structuring steps 664, 666, 668, in this case each on their own or independently of one another, may again be designed and configured in accordance with the method explained in more detail with reference to FIG. 3.

In a further data comparison and fusion step 670, the data clusters respectively ascertained in the course of the data selection and structuring steps 660, 662, 664, 666, 668 are then associated with one another. This association is performed such that in each case those data clusters of the various data sources 200, 400, 152, 154, 156 that belong to the same component types, component type designations, component ID information and/or component ID information designations are each associated with one another.

This model comparison and fusion step 670 thus generates a consistent data model for the assembly station 100 beyond the limits of the various data sources 200, 400, 152, 154, 156 and is thus a good basis for creating a digital twin 800 in accordance with the present disclosure.

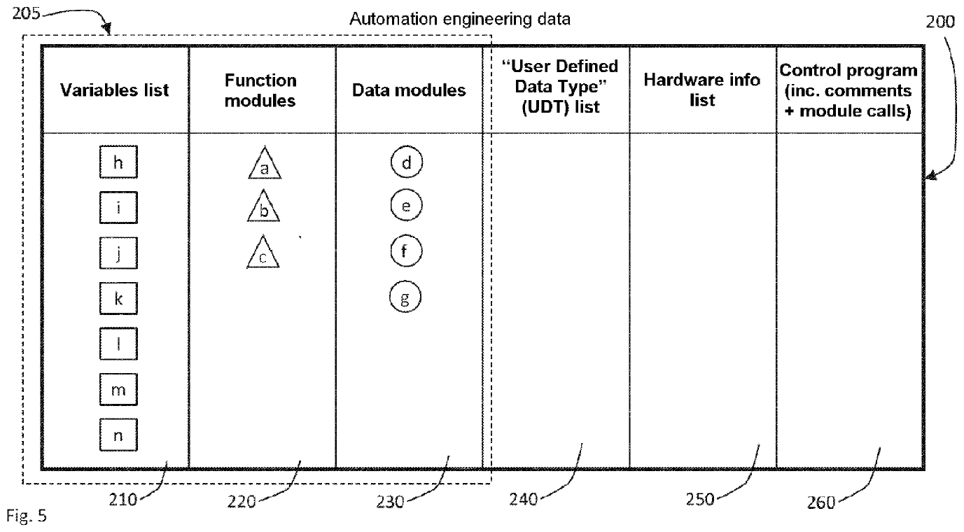

The method steps 610, 620, 630, 640, 650, already explained with reference to FIG. 3, are now intended to be explained in more detail by way of example with reference to FIGS. 5-8 using the example of exemplary automation engineering data 200 for the assembly station 100.

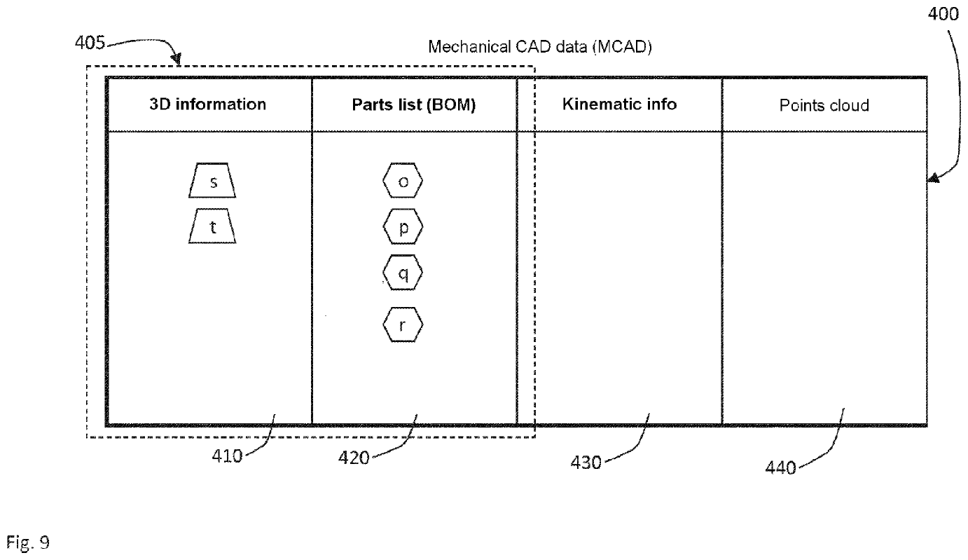

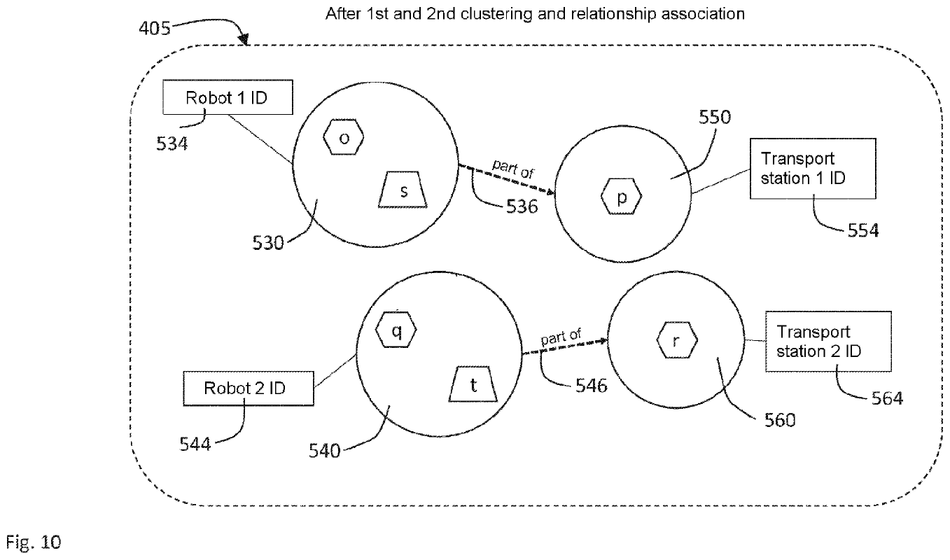

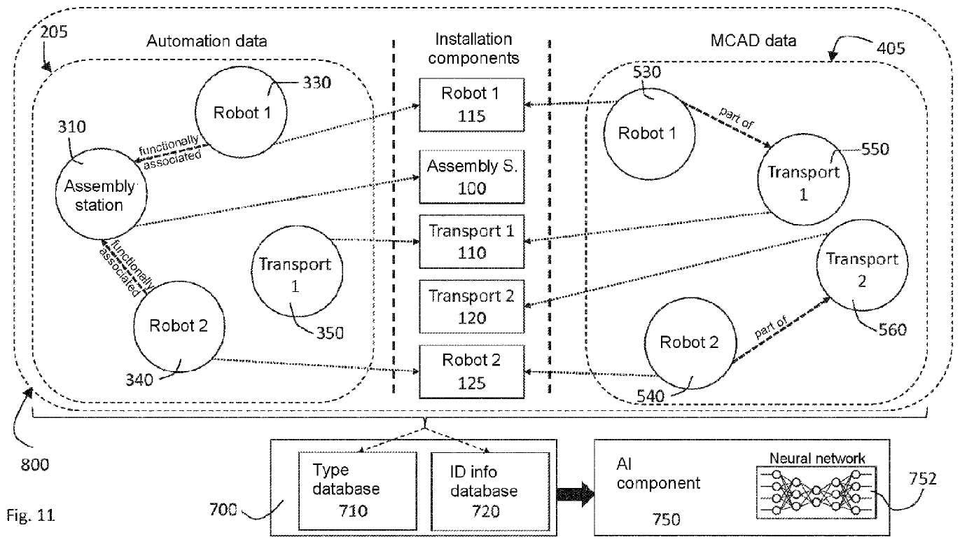

Similar clustering based on exemplary MCAD data 400 for the assembly station 100 is explained with reference to FIGS. 9-10, following which the model comparison and fusion step 670, already explained in more detail in connection with FIG. 4, is then explained in more detail by way of example with reference to FIG. 11 on the basis of the data clusters identified in relation to the clustering analysis of the automation engineering data 200 according to FIGS. 5-8 and the MCAD data 400 according to FIGS. 9-10.

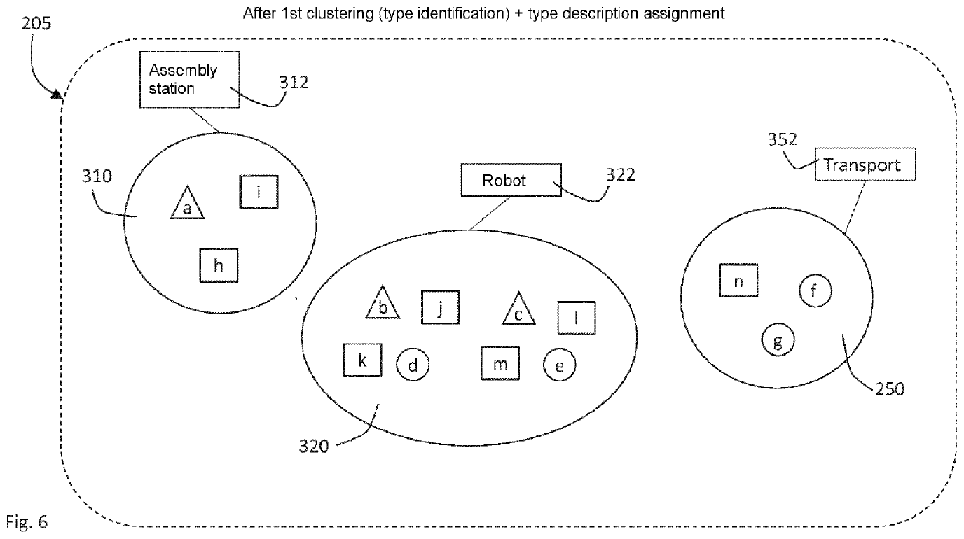

FIG. 5 shows one exemplary example of automation engineering data 200 for the assembly station 100. In this example, the automation engineering data 200 comprise a variables list 210 containing the variables h to n, each of which is identified by a square symbol. The automation engineering data 200 furthermore comprise a function module list 220 containing function modules a to c, these being illustrated by triangular symbols. The automation engineering data 200 furthermore comprise a data module list 230 containing data modules d to g, each of which is illustrated by circular symbols. The automation engineering data 200 furthermore also comprise a UDT list, 240, a hardware information list 250 and a control program 260, these however not being used in the clustering exemplary embodiment illustrated in FIGS. 6-8.

FIG. 6 shows the result of a first clustering step for identifying clusters 310, 320, 250 that are each associated with component types of the assembly station 100. Such a clustering step may, for example, be configured as explained in more detail in the first clustering step in 610 the context of FIG. 3.

FIG. 6 furthermore also shows the result of a following type description assignment step for assigning appropriate component type designations 312, 322, 352 to the corresponding clusters 310, 320, 250. Such a type assignment step may, for example, be configured in accordance with the first type description assignment step 620 of FIG. 3.

For the first clustering step 610, the variables list 210, the function module list 220 and the data module list 230 are selected from the automation engineering data 200 of FIG. 5 in the form of a data selection 205 or first data source 205. Respectively associated variable names are then used for the clustering in relation to the variables h to n. Variables used in each case by the function modules or their associated names are used for the function modules a to c. Variables used by the data modules for the clustering or their associated names are likewise used for the data modules d to g.

The selected variable names used for the clustering are, for example, well-suited to the corresponding clustering because, when allocating variable names in the context of engineering, such as for the assembly station 100, the membership of variables to particular components, subcomponents or installation parts is usually jointly coded into the variable name. It is thus, for example, possible to conclude, from the match between particular parts of a variable name, as to a corresponding common feature when associating these variables with different components, component parts or subcomponents of the assembly station 100.

After selecting and performing an appropriate clustering method on the abovementioned data, for example, in accordance with the present description, the cluster image illustrated in FIG. 6 is then obtained, in which the variables i and h and the function module a are associated with a first cluster 310. The variables k, j, l, m, the function modules b and c and the data modules d and e are contained in a second cluster 320. Furthermore, the variable n and the data modules g and f are associated with a third cluster 250.

Next, in a further step, respectively appropriate component type designations 312, 322, 352 are assigned to the identified clusters 310, 320, 250. This component type designation assignment may, for example, be configured in accordance with the present description or else as in the component description assignment step 620 illustrated in connection with FIG. 3.

In the present example, this assignment of component type designations 312, 322, 352 may, for example, occur in a partially automated manner where, for example, for the data contained in the first data cluster 310, meta-information regarding these data or description information regarding these data is used and a search for matches in these data occurs. If this search unambiguously reveals a common feature, then this may, for example, be displayed to a user as a suggestion to be confirmed. The user may, for example, accept the suggestion, as a result of which this term is then assigned as component type designation 312, 322, 352 for the respective one of the clusters 310, 320, 250. In the case of various matches between the data, a corresponding selection may, for example, be displayed to a user, who then selects the suitable component type designation 312, 322, 352 for the respective one of the clusters 310, 320, 250.

This method may also run in a fully automated manner, according to which the system evaluates the found matches itself using an appropriate method and generates an appropriate component type designation 312, 322, 352 therefrom and associates it with the respective one of the clusters 310, 320, 250. This association may then for example be changed again subsequently by a user.

This assignment step may furthermore also occur completely manually by a user, for example, manually evaluating the meta-information or description information currently being displayed and forming an appropriate component type designation 312, 322, 352 for the respective one of the clusters 310, 320, 250 therefrom.

In the present example, a component type designation “assembly station” 312 has been ascertained through one of three ways mentioned above for the first cluster 310 and associated with this cluster 310. In functional terms, this means that the data contained in the cluster, the variable a and the function modules i and h, may be associated as a whole with the overall functionality of the assembly station 100.

In the same way, a cluster type designation “robot” 322 has been associated with the second cluster 320. In functional terms, the data contained in this second data cluster 320 may thus be associated with the functionality of the robot 115, 125 within the assembly station 100.

Again, in the same way, the type designation “transport” 352 has been associated with the third cluster 250. The functionality of the data contained in the second cluster 250 may thus be associated with transport stations one and two 110, 120 of the assembly station 100.

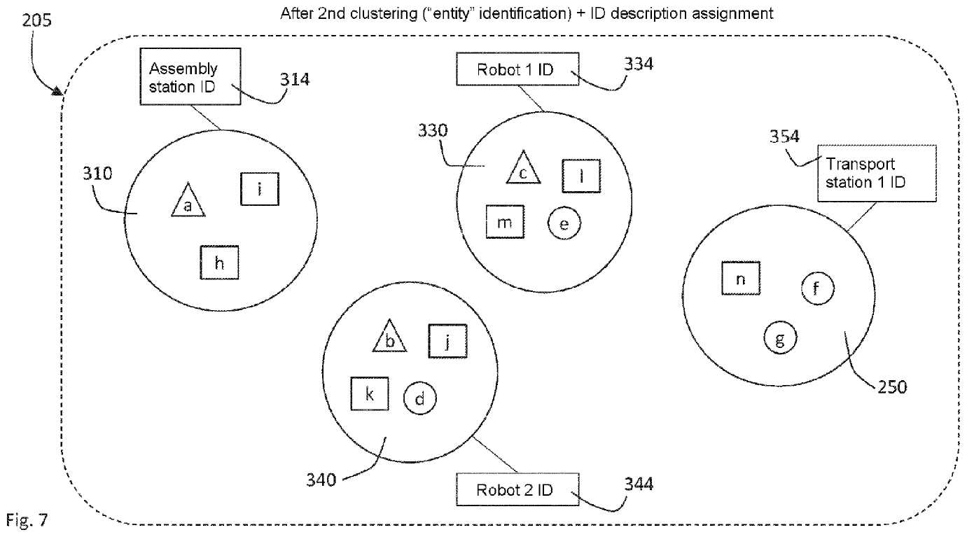

FIG. 7 shows the result after a second clustering step 630 for identifying component ID information clusters and a second assignment step 640 for assigning component ID information designations to the identified clusters according to the explanations in relation to FIG. 3 have been applied to the clusters illustrated in FIG. 6.

The result of the second clustering step 630 is in this case four clusters 310, 330, 340, 250. Here, the first cluster 310 corresponds to the first cluster 310 already identified in the first clustering step and the fourth cluster 250 corresponds to the third cluster 250 defined in the first step.

A conclusion may be drawn from this, for example, that the data associated with the type “assembly station” according to the first clustering step 610 can be associated with precisely one assembly station having specific ID information. In the same way, the data associated with the type “transport station” according to the first clustering step 610 in the corresponding data cluster 250 may be assigned to exactly one particular transport station having a particular transport station ID identifier. The second clustering step 610 has thus, in these two cases, not identified any new clusters, rather the second clustering 610 has not resulted in any change to the cluster structure here.

The case is different in relation to the second cluster 320, identified in the first clustering step 610, which is associated with the component type “robot”. Applying the second clustering step 630 has resulted here in the data contained in the type cluster 320 being divided into two component ID information clusters 330, 340, as is illustrated in FIG. 7. In this case, the variables l to m, the function module c and the data module e belong to a first of these clusters 330. The variables j to k, the function module b and the data module d are associated with a second of these clusters 340. From this, it is possible to drawn the conclusion, for example, that the data assigned to the component type “robot” may be associated with two different robot entities.

In accordance with the first description assignment step 620, appropriate component ID information designations 314, 334, 344, 354 may then also be assigned for the clusters identified in the second clustering step 630. Here, specific ID information 314 for the assembly station 100 may again be assigned to the first cluster 310 based on the description and meta-information assigned to the corresponding variables. A unique ID identifier of the first robot 115 of the assembly station 100 is then assigned to the second component ID information cluster 330, while a unique ID identifier of the second robot 125 of the assembly station 100 is assigned to the third component ID information cluster 340. In the same way, a unique ID identifier 352 for the first transport station 110 of the assembly station 100 has then been assigned to the fourth component ID information cluster 250.

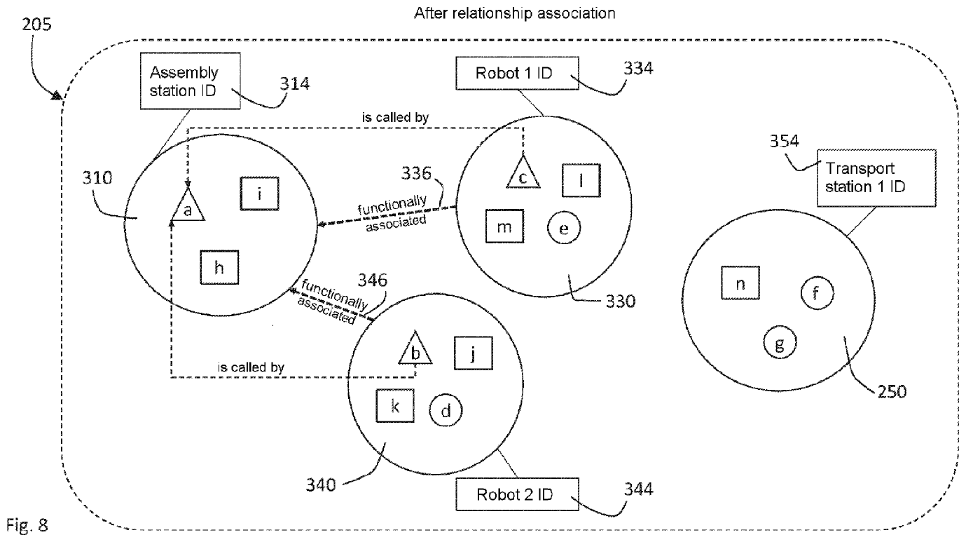

FIG. 8 shows the result of a relationship association step 650 following the previous method steps 610, 620, 630, 640, as has been explained in more detail with reference to FIG. 3. This relationship association step 650 has been applied to the corresponding clustering result of FIG. 7. In order to identify relationship associations between the clusters 310, 330, 340, 250 illustrated in FIG. 7, a call structure or call chain, can taken from the function module list 220, has been evaluated in an automated manner for the function modules a to c. As an alternative, this evaluation may also occur in a partially automated manner in accordance with the present disclosure, or manually.

The result of this evaluation is illustrated in FIG. 8. Here, dot-and-dash arrows between the function modules a and c and also a and b illustrate that the function module c is called by the function module a and the function module b is likewise called by the function module a. The function module a is assigned to the cluster 310 for the assembly station 100 having the assembly station identifier 314, the function module b is assigned to the second robot 125 having the second robot identifier 344, and the function module c is assigned to the first robot 115 having the first robot ID identifier 334. It is then possible to conclude from the call association explained above that the data cluster 330 assigned to the first robot 115 is functionally associated with the data cluster 310 associated with the assembly station 100, this being illustrated by a dashed arrow 336 in FIG. 8. In the same way, the data cluster 340 associated with the second robot 125 is likewise associated with the data cluster 310 associated with the assembly station 100, this again being illustrated by a dashed arrow 346 in FIG. 8.

FIGS. 9 and 10 explain, by way of example, an application of method steps 610, 620, 630, 640, 650, which have already been explained in more detail with reference to FIG. 3, to mechanical CAD data 400 associated with the assembly station 100. Here, the basic sequence of method steps 610, 620, 630, 640, 650 corresponds to the sequence explained above with respect to FIGS. 5 to 8 in relation to a corresponding clustering of the automation engineering data 200 for the assembly station 100.

FIG. 9 shows MCAD data 400 for the assembly station 100. These MCAD data 400 comprise a list of 3D information 410 regarding components of the assembly station 100, these being illustrated by trapezoids having the letters s and t in FIG. 9. The MCAD data 400 furthermore comprise a parts list 420 that contains information regarding four individual components of the assembly station 100, these being symbolized by hexagons having the letters o to r. The MCAD data 400 furthermore comprise a list containing kinematic information 430 and a list containing points cloud information 440. For the clustering steps explained below, the 3D information list 410 and the parts list 420 have been selected, this being illustrated by a selection 405 illustrated in the form of a dotted rectangle in FIG. 9.

FIG. 10 shows the result of the clustering of the MCAD data according to the selection 405, illustrated in FIG. 9, from the entire set of MCAD data 400. The clustering result, illustrated in FIG. 10, for the MCAD data 405 corresponds to the clustering result, illustrated in FIG. 8, for the corresponding automation engineering data 205. Here, FIG. 10 shows the result of the clustering after the method steps 610, 620, 630, 640, 650 explained with reference to FIG. 3 have been applied to the MCAD data 405. Here, these method steps are applied in the same way as how these steps are applied as explained in relation to the automation engineering data 200 in connection with FIGS. 5 to 8.

FIG. 10 therefore shows the result following a sequence of a first clustering step 610 by component types, a first designation step of the clusters identified in the process with component type designations 620, a second clustering step 630 by component ID information and a following second designation step 640 of designating the clusters identified in the process with component ID information designations. This is then followed again, as a last step, by a relationship association step 650 for identifying relationships between the ID information clusters identified in the second clustering step 630.

This then results, as illustrated in FIG. 10, in a first cluster 530 that is associated with the first robot 115 of the assembly station 100, and to which ID information for this first robot 534 has therefore been assigned. This first robot cluster 530 comprises the parts “o” according to the parts list 420 of the MCAD data 400 and the 3D information “s”. A second cluster 540 is assigned to the second robot 125 of the assembly station 100. The cluster 540 therefore has an associated ID identifier of the second robot 544 as component ID information designation 544. This second robot cluster 540 comprises information regarding component “q” from the parts list 420 of the MCAD data 400 and the 3D information “t”.

FIG. 10 furthermore shows a cluster 550 assigned to the first transport station 110, with which an ID identifier of this first transport station 554 is associated as component ID information designation. This cluster contains the information “p” from the parts list 420 of the MCAD data 400. FIG. 10 furthermore shows a cluster 560 assigned to the second transport station 120, with which the ID identifier of this second transport station 564 is associated as component ID information designation. This cluster contains the information “r” from the parts list 420 of the MCAD data 400.

Analyzing, for example, information, contained in the parts list 420 of the MCAD data 400, regarding the components o to r has furthermore made it possible to ascertain the information that the first robot 115 is part of the transport station 110 and the second robot 125 is part of the transport station 120. These relationships were likewise associated with the respective clusters 530, 540, 550, 560 for said components 110, 115, 120, 125 by virtue of a corresponding “part of” relationship having been associated with the cluster 530 for the first robot 115 and the cluster 550 for the first transport station 110, this being symbolized in FIG. 10 by a dashed arrow 536 between these clusters 530, 550. A corresponding “part of” relationship is accordingly associated with the cluster 540 for the second robot 125 and the cluster 560 for the second transport station 120, this being symbolized in FIG. 10 by a dashed arrow 546 between both clusters.

FIG. 11 shows the result of applying a model comparison and fusion step 670, as has been illustrated in more detail for example in connection with the explanations in relation to FIG. 4. In this case, FIG. 11, in a left-hand part, shows a simplified illustration of the clustering result in relation to the automation engineering data 205, as illustrated in FIG. 8. Furthermore, a right-hand part in FIG. 11 shows a simplified illustration of the clustering result in relation to the MCAD data 405, as has been illustrated in FIG. 10.

In the course of the model comparison and fusion step 670, all identified component ID information designations 314, 334, 344, 354, 534, 544, 554, 564 were then collected and in each case appropriate symbols for corresponding components 100, 110, 115, 120, 125 were associated with these designations. This symbolic illustration of components for the assembly station 100, the first transport station 110, the first robot 115 of the first transport station 110 and the second transport station 120 with its second robot 125 is illustrated in a central excerpt in FIG. 11.

FIG. 11 furthermore illustrates, in each case by way of arrows between the respective clusters 330, 310, 340, 350 of the automation engineering data 205 and the respective clusters 530, 540, 550, 560 of the MCAD data 405, an association of the corresponding clusters with these installation parts 100, 110, 115, 120, 125 symbolized by rectangles in the central part of FIG. 11.

The information identified in this case and illustrated in FIG. 11 is then fixed in the form of an appropriate database to create a corresponding digital twin 800 for the assembly station 100. Here, both the associations of the individual data from the automation engineering data 205 and MCAD data 405 with the various clusters, their respective component type designations and their component ID information designations, along with the relationships between the various clusters and with the components of the assembly station 100, are accordingly recorded and stored in the digital twin 800.

Furthermore, this digital twin 800 also stores corresponding links between the individual data in the digital twin 800 regarding the original automation engineering source data 205 and MCAD source data 405, via which a connection and thus also access to the original data source is enabled. It is thus also possible to access all of the information stored there. By way of example, it is advantageously suitable to store this digital twin 800 in a knowledge graph database format or else a comparable NoSQL database format. Here, in FIG. 11, the illustration of the result of the model comparison and fusion step 670 may be considered to be a possible illustration of the digital twin 800 of the assembly station 100.

Based on this digital twin 800, it is then, for example, furthermore possible to create a simulation for the assembly station 100 or parts thereof. For this purpose, the component ID information designations 314, 334, 344, 354, 534, 544, 554, 564 identified in the course of creating the digital twin 800 may, for example, be used to appropriately select simulations corresponding to the corresponding component therefor, for example, from a database collection of such simulations. These simulations may then furthermore be parameterized, configured and linked to one another using the corresponding associated data from the associated data clusters. It is thereby possible to create a simulation of the assembly station 100 based on the created digital twin 100. The creation of this simulation may in turn also be considered to be creation of a digital twin in the context of the present disclosure. The simulation thus created is also a further possible embodiment of a digital twin in the context of the present disclosure.

FIG. 11 furthermore illustrates the database 700 containing the type database 710 and the ID information database 720 that have already been explained in the course of the description of FIG. 3. FIG. 11 also shows the AI component 750 with the neural network 752, which has likewise already been explained in more detail in the course of the description of FIG. 3. Corresponding connecting arrows in FIG. 11 symbolize that the result and the information are stored in the digital twin 800 in the course of the type database 710 and the ID information database 720, and these data are also used to train the neural network 752 in the AI component 750, as already explained in connection with FIG. 3.

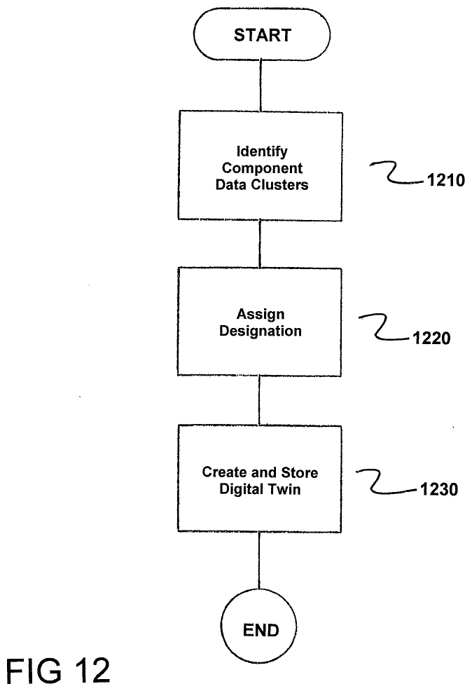

FIG. 12 is flowchart of the method for creating a digital twin 800 of an installation or device 100, where a first data source containing automation engineering data 205 related to automation and/or an automation plan of the installation or device 100 or parts thereof is present, and the automation engineering data 205 comprises data from at least two data categories.

The method comprises a.) identifying component data clusters 310, 320, 330, 340, 250 within the automation engineering data 205, as indicated in step 1210. In accordance with the invention, the component data clusters 310, 320, 330, 340, 250 are able to be associated or associated with component types or component ID information related to the installation or device 100.

Next, b.) a respective component type designation 312, 322, 352 or a respective component ID information designation 314, 334, 344, 354 is assigned to at least one of the identified component data clusters 310, 320, 330, 340, 250, as indicated in step 1220.

Next, c.) the digital twin 800 of the installation or device 100 is created and stored, as indicated in step 1230.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-17. (canceled)

18. A method for creating a digital twin of an installation or device, a first data source containing automation engineering data related to at least one of automation and an automation plan of the installation or device or parts thereof being present, and the automation engineering data comprising data from at least two data categories, the method comprising:
a.) identifying component data clusters within the automation engineering data, the component data clusters be associable with or being associated with component types or component ID information related to the installation or device;
b.) assigning a respective component type designation or a respective component ID information designation to at least one of the identified component data clusters; and
c.) creating and storing the digital twin of the installation or device.

19. The method as claimed in claim 18, wherein subsequent to method step a.) and before method step c.), the method further comprises:
a1.) identifying subcomponent data clusters within the identified component data clusters, wherein the subcomponent data clusters are able to be associated with or associated with subcomponent types or subcomponent ID information related to the installation or device; and
wherein subsequent to method step a1.) and before method step c.), the method further comprising:
b1.) assigning a respective subcomponent type designation or a respective subcomponent ID information designation to at least one of the identified subcomponent data clusters.

20. The method as claimed in claim 18, wherein subsequent to at least one of method step a.) and a1.), the method further comprising:
b2.) identifying relationship information of the component data clusters identified in accordance method step a.) by evaluating at least one of the automation engineering data and additional information regarding these data, and/or identifying relationship information between subcomponent data clusters identified in accordance with method step a1.) by evaluating at least one of the data from the automation engineering data and the additional information regarding these data; and
wherein during method step c.), the digital twin is additionally created utilizing identified relationship information.

21. The method as claimed in claim 19, wherein subsequent to at least one of method step a.) and a1.), the method further comprises:
b2.) identifying relationship information of the component data clusters identified in accordance method step a.) by evaluating at least one of the automation engineering data and additional information regarding these data, and/or identifying relationship information between subcomponent data clusters identified in accordance with method step a1.) by evaluating at least one of the data from the automation engineering data and the additional information regarding these data; and
wherein during method step c.), the digital twin is additionally created utilizing identified relationship information.

22. The method as claimed in claim 18, wherein a second data source from the following data sources is present:
mechanical computer-aided design data at least one of (i) related to a mechanical and/or spatial plan of the device or installation or parts thereof and (ii) related to a mechanical and/or spatial design of the device or installation or parts thereof,
electrical computer-aided design data at least one of (i) related to an electrical plan and/or circuit diagram of the device or installation or parts thereof and (ii) related to an electrical design and/or implemented circuit diagram of the device or installation or parts thereof,
robotics data related to at least one of a plan and a design of one or more robots of the device or installation, and
description data related to at least one of a plan and/or design of the device or installation or parts thereof;
wherein the method further comprises, before the creation of the digital twin in accordance with step c.):
aa.) identifying component data clusters within the second data source, the component data clusters being associable with or associated with component types or component ID information related to the installation or device;
bb.) assigning a respective component type designation or a respective component ID information designation to at least one of the component data clusters identified in method step aa.);
bbb.) associating at least one of the component data clusters and subcomponent data clusters of the automation engineering data identified with the component data clusters identified in method step bb.).

23. The method as claimed in claim 22, wherein subsequent to method step aa.) and before method step bbb.), the method further comprises:
aa1.) identifying identified subcomponent data clusters within the component data clusters, subcomponent types or subcomponent ID information related to the installation or device being associable with or being associated with the subcomponent data clusters; and
bb1.) assigning a respective subcomponent type designation or a respective subcomponent ID information designation to at least one of the identified subcomponent data clusters.

24. The method as claimed in claim 22, wherein subsequent to at least one of method step aa.) and aa1.), the method further comprises:
bb2.) identifying at least one of (i) relationship information between component data clusters identified in accordance with method step aa.) by evaluating at least one of the data from the second data source and additional information regarding these data, (ii) relationship information between subcomponent data clusters identified according to method step aa1.) by evaluating the data from at least one of the second data source and additional information regarding these data; and
wherein during method step c.), the digital twin is additionally created utilizing the identified relationship information.

25. The method as claimed in claim 23, wherein subsequent to at least one of method steps a.), a1.), aa.), aa1.), b.), b1.), b2.), bb.), bb1.), bb2.) and bbb.), a result of the respective method step is stored in a cluster association database and/or wherein subsequent to at least one of method steps a.), a1.), aa.), aa1.), b.), b1.), b2.), bb.), bb1.), bb2.) and bbb.), a cluster association neural network is trained utilizing results from a respective method step.

26. The method as claimed in claim 25, wherein at least one of the cluster association database and the cluster association neural network is utilized when performing the method, said utilization comprising at least one of (i) the component data clusters and the subcomponent data clusters being identified utilizing the cluster association database and the cluster association neural network and (ii) at least one of the component type designation or component ID information designation and the subcomponent type designation or in each case one subcomponent ID information designation is assigned utilizing at least one of the cluster association database and the cluster association neural network.

27. The method as claimed in one of the preceding claim 18, wherein at least one of the digital twin and the cluster association database is formed as at least one of a relational database, a NoSQL database and a knowledge graph database.

28. A method for creating a digital twin of an installation or device, a first data source from the following data sources being present:
automation engineering data related to at least one of automation and an automation plan of the installation or device or parts thereof,
mechanical computer-aided design data at least one of (i) related to a mechanical and/or spatial plan of the device or installation or parts thereof and (ii) related to a mechanical and/or spatial design of the device or installation or parts thereof,
electrical computer-aided data at least one of (i) related to an electrical plan and/or circuit diagram of the device or installation or parts thereof (ii) related to an electrical design and/or implemented circuit diagram of the device or installation or parts thereof, and
robotics data related to at least one of a plan and a design of one or more robots of the device or installation, the first data source comprising data from at least two data categories, the method comprising:
a.) identifying component data clusters within the first data source, the component data clusters being associable with or associated with component types or component ID information related to the device or installation,
b.) assigning a respective component type designation or a respective component ID information designation to at least one of the identified component data clusters; and
c.) creating and storing the digital twin of the installation or device.

29. The method as claimed in claim 28, wherein subsequent to at least one of method step a.) and a1.), the method further comprising:
b2.) identifying relationship information of the component data clusters identified in accordance method step a.) by evaluating at least one of the automation engineering data and additional information regarding these data, and/or identifying relationship information between subcomponent data clusters identified in accordance with method step a1.) by evaluating at least one of the data from the automation engineering data and the additional information regarding these data; and
wherein during method step c.), the digital twin is additionally created utilizing identified relationship information; and
wherein the automation engineering data are each replaced by the first data source.

30. The method as claimed in claim 28, wherein a second data source, different from the first data source, is selected from the following data sources:
the automation engineering data related to at least one of automation and/or an automation plan of the installation or device or parts thereof,
the MCAD data at least one of (i) related to a mechanical and/or spatial plan of the device or installation or parts thereof and related to a mechanical and/or spatial design of the device or installation or parts thereof,
the ECAD data at least one of (i) related the electrical plan and/or circuit diagram of the device or installation or parts thereof and (ii) related to the electrical design and/or implemented circuit diagram of the device or installation or parts thereof,
the robotics data in related to the plan and the design of one or more robots of the device or installation, and
description data related to a plan and/or design of the device or installation or parts thereof;
wherein the method further comprises, before the creation of the digital twin in accordance with step c.):
aa.) identifying component data clusters within the second data source, the component data clusters being associable with or associated with component types or component ID information related to the installation or device;
bb.) assigning a respective component type designation or a respective component ID information designation to at least one of the component data clusters identified in method step aa.); and
bbb.) associating at least one of the component data clusters and subcomponent data clusters from the first data source identified in method step b.) with the component data clusters identified in method step bb.).

31. The method as claimed in claim 29, wherein a second data source, different from the first data source, is selected from the following data sources:
the automation engineering data related to at least one of automation and/or an automation plan of the installation or device or parts thereof,
the MCAD data at least one of (i) related to a mechanical and/or spatial plan of the device or installation or parts thereof and related to a mechanical and/or spatial design of the device or installation or parts thereof,
the ECAD data at least one of (i) related the electrical plan and/or circuit diagram of the device or installation or parts thereof and (ii) related to the electrical design and/or implemented circuit diagram of the device or installation or parts thereof,
the robotics data in related to the plan and the design of one or more robots of the device or installation, and
description data related to a plan and/or design of the device or installation or parts thereof;
wherein the method further comprises, before the creation of the digital twin in accordance with step c.):
aa.) identifying component data clusters within the second data source, the component data clusters being associable with or associated with component types or component ID information related to the installation or device;
bb.) assigning a respective component type designation or a respective component ID information designation to at least one of the component data clusters identified in method step aa.); and
bbb.) associating at least one of the component data clusters and subcomponent data clusters from the first data source identified in method step b.) with the component data clusters identified in method step bb.).

32. The method as claimed in claim 30, wherein subsequent to method step aa.) and before method step bbb.), the method further comprises:
aa1.) identifying identified subcomponent data clusters within the component data clusters, subcomponent types or subcomponent ID information related to the installation or device being associable with or being associated with the subcomponent data clusters; and
bb1.) assigning a respective subcomponent type designation or a respective subcomponent ID information designation to at least one of the identified subcomponent data clusters.

33. A digital twin for a device or installation, the digital twin being created utilizing the method as claimed in claim 18.

34. A non-transitory computer-readable storage medium comprising at least one of a digital twin, a cluster association database and a cluster association neural network as claimed in claim 18.

35. The method as claimed in claim 22, wherein the digital twin is utilized to identify inconsistencies between the automation engineering data and the data from the second data source.

36. The method as claimed in claim 30, wherein the digital twin is utilized to identify inconsistencies between the data from the first data source and the data from the second data source.

37. The digital twin as claimed in 33, wherein the digital twin is configured to at least one of:
create a digital twin of a changed device or installation;
create a simulation of the device or installation or parts thereof and/or virtually commission the device or installation or parts thereof; and
check whether the digital twin corresponds to original planning data of the device or installation.
